(19) United States
(12) Patent Application Publication
(10) Pub. No.: US 2005/0237480 A1
(43) Pub. Date: Oct. 27, 2005

(54) Chemical modifications to polymer surfaces and the application of polymer grafting to biomaterials

(75) Inventors: Nancy Allbritton, Irvine, CA (US); Christopher E. Sims, Irvine, CA (US); Guann-Pyng Li, Irvine, CA (US); Mark Bachman, Irvine, CA (US); Shuwen Hu, Irvine, CA (US); Xueqin Ren, Irvine, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: The Regents of the University of California, Oakland, CA (US)

(21) Appl. No.: 10/511,788

(22) PCT Filed: May 13, 2003
(86) PCT No.: PCT/US03/15192

§ 371 Date: Oct. 14, 2004

Related U.S. Application Data
(60) Provisional application No. 60/380,231, filed on May 13, 2002.

(51) Int. Cl. G02C 7/04

(52) U.S. Cl. 351/160 R

(57) ABSTRACT

Polymer-based biomaterials are popular due to ease of fabrication and low costs. However, many polymer substrates have undesirable surface properties. The invention provides a procedure to covalently apply a graft polymer to the surface of a polymer substrate by ultraviolet graft polymerization. The graft polymer is formed from monomers such as PEG, AA, monomethoxy acrylate PEG, HEMA, or DMA. Also, mixed monomers may be used to create the graft and the surface properties of the graft may be tailored for different properties, including hydrophobicity, friction coefficient, electroosmotic mobilities and electrophoretic separations. The invention has particular utility in tailoring surface chemistries in ocular lenses and polymer microdevices.

I.

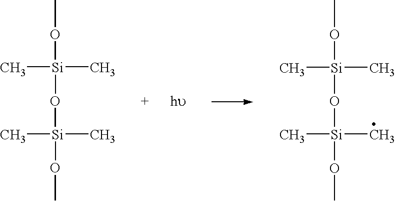

II.

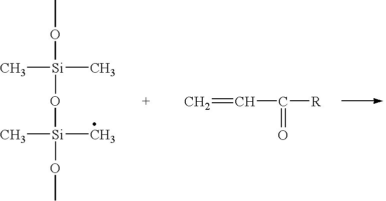

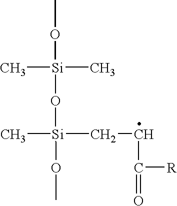

| | | |
|---|---|---|
| R: | —OH | Acrylic Acid(AA) |
| | —NH₂ | Acrylamide (AM) |
| | —N(CH₃)₂ | Dimethylacrylamide (DMA) |
| | —OCH₂CH₂OH | 2-Hydroxyethylacrylate (HEA) |
| | —O(CH₂CH₂O)ₙCH₃ | PEG monomethyoxylacrylate (PEG) |

This invention was made in part from government support under Grant Nos. CA78858 and RR/CA114892, National Institutes of Health (NIH) of the United States. The U.S. Government may have certain rights in this invention.

### FIELD OF INVENTION

Ultraviolet-based graft polymerization using a substrate susceptible of a free radical reaction and selected monomers yields surface properties that can be tailored for use with biomaterials used in medical applications, in specialized biocompatible polymer applications such as ocular lenses, and analytical devices, including particularly polymer-based microdevices.

### BACKGROUND

Specially engineered polymer substrates play an important role in medicine, surgery, and analytical biochemistry by providing materials, often referred to as biomaterials, that feature unique characteristics that are important in biological systems. These polymers can be found in surgical implants, lenses, and medical devices used directly with patients, and in analytical devices where biological samples are analyzed. Moreover, these polymer substrates may be modified with specially engineered surface coatings or treatments that enhance the utility of these polymers in several important applications. Known surface treatments involve chemical coating, radiation treatments, and several other techniques to alter the physical characteristics of a surface. Surface treatments for polymer substrates and other biomaterials are typically designed based on the application for which the polymer substrate is intended. One particularly interesting approach applies a polymer layer to an existing polymer substrate to tailor the surface chemistry for a particular purpose. The application of an additional polymer layer, or “graft,” to an existing polymer substrate significantly enhances the utility of many conventional polymers.

Methods for modifying the surface of polymer substrates for use in biomedical or other applications include the use of coatings (addition), surfactant addition (blending), etchings (roughening), argon or nitrogen plasmas (ion implantation), oxygen plasma or corona discharge (oxidation), exposure to flame or reaction to alkalines (oxidation), and exposure to UV, plasma, or ionizing radiation with chemical treatment (graft polymerization). For many important medical applications, the addition and blending methods are undesirable because contaminants break down or leech from the polymer substrate over time. Physical methods of modification of a polymer substrate often result in limited functionality or in the requirement for difficult and/or expensive procedures.

Despite the difficulties, surface modifications, both chemical and physical, are in widespread use to tailor the surface properties of polymer substrates for biomedical applications. Chan, C. M. Polymer Surface Modification and Characterization, Hanser/Gardner Publications: Cincinnati, 1994; Chapters 1, 2, 5; Garbassi, F.; Morra, M.; Occhiello, E. Polymer Surfaces, 2nd ed.; John Wiley and Sons: New York, 1998; Chapters 2, 6, 7, 12. These applications include coatings for catheters, prostheses, grafts, and other implants. Typical goals are a decrease in biomolecular adsorption, an increase in the hydrophilic or hydrophobic character of the surface, the attachment of a biologically active molecule, or an alteration in the lubricity of the surface. Ikada, Y. Biomaterials 1994, 15, 725-36; Belanger, M. C.; Marois, Y. J. Biomed. Mater. Res. (Appl. Biomater.) 2001, 58, 467-77; Jagur-Grodzinski, J. Heterogeneous Modification of Polymers, John Wiley and Sons: New York, 1997; Chapters 7, 8. Graft polymerization, in particular, has seen widespread use in applications where a surface layer is intended to produce biocompatibility. Chan, C. M, supra. Typically the process involves the creation of reactive sites (radicals) on the polymer surface followed by covalent linkage of a preformed polymer, or more commonly a monomer which can then be used as the initiation site for a polymeric chain. Radicals on a previously inert polymer surface are created by application of chemical reactants, or by exposure to ionizing radiation or ultraviolet (UV) light, which is also used in the curing process for some polymer substrates.

UV light-based graft polymerization has already been demonstrated for applying surface coating to polymers, including polypropylene, poly(ethylene terephthalate) and polyethylene. However, each application requires a selected substrate and a selected monomer or group of monomers to yield the desired surface properties for the individual application, which is often determined empirically. Previous efforts have not effectively yielded definitive substrates, monomers, utilized cross-linking agents or chain transfer agents, that can be tailored for a broad variety of applications according to preselected properties of the material. For example, the substrate, monomer, and reaction conditions that produce a successful impermeable polymer graft for a rigid medical device will not yield acceptable results for a thin film substrate where transparency and gas permeability is required. In many applications, the polymer graft must be uniquely tailored to balance the requirements of the underlying application with the physical parameters produced by the graft itself In the example of an ocular lens, described in further detail below, the physical requirements for a polymer graft are completely different than those required for a hard surface coating. For example, the polymer graft for a contact lens must be transparent to visible light, permeable to oxygen and other gases that must pass through the polymer graft as well as the underlying lens material to reach the surface of the eye. Also, the polymer graft must be wettable so that a thin film of fluid can be maintained across the surface. The underlying substrate and the polymer graft must be flexible, tolerant to the thermal and pressure strains of a sterilization process, and must have a low friction coefficient. These requirements are substantially different than the requirements for a graft polymer used in a microdevice where extremely small volumes of biological material are processed, separated, and analyzed for diagnostic purposes. These polymer microdevices provide a lab-on-a-chip capability to produce a series of chemical reactions in a highly miniaturized format.

The field of polymer microdevices is uniquely interesting because those microdevices offer the ability to miniaturize entire laboratories into chip-sized devices that perform sophisticated biochemical reactions on an extremely small scale. Polymer-based microfluidic devices are rapidly gaining in popularity primarily due to their ease of fabrication, inexpensive costs, and increasing versatility. Becker, H.; Gartner, C. Electrophoresis 2000, 21, 12-26; Bruin, J. M. Electrophoresis 2000, 21, 3931-51; Quake, S. R.; Scherer, A. Science 2000, 290, 1536-40. These devices involve the use of microfluidics, a process whereby extremely small volumes of fluid are manipulated to perform analytical chemical reactions in extremely minute quantities. Also, these devices require highly exacting surface properties to separate compounds in a biological sample while also providing the capability to analyze the separated compounds. For surface treatment of microfluidic devices, most work has focused on using plasma-based surface modification or dynamic coating where materials are adsorbed on the walls of the device to alter the surface chemistry.

Polymer-based microdevices have also been fabricated from a variety of different polymers including polymethylmethacrylate (PMMA), polycarbonate, polystyrene, and polydimethylsiloxane (PDMS). In particular PDMS-based devices can easily and inexpensively be fabricated by casting the polymer against a mold prior to cross linking. McDonald, J. C.; Duffy, D. C.; Anderson, J. R.; Chiu, D. T.; Wu, H.; Schueller, O. J. A.; Whitesides, G. M. Electrophoresis 2000, 21, 27-40. PDMS is durable and can readily seal either reversibly or irreversibly to a variety of substrates including PDMS itself, other polymers such as PMMA, and glass. Interest in the surface modification of polymeric substrate materials such as poly(dimethylsiloxane) (PDMS) and poly(methyl methacrylate) has increased over the years along with the development of microfluidic devices. Becker, H.; Gartner, C. Electrophoresis 2000, 21, 12-26. Silicone rubbers including PDMS have successfully been modified by radiation-induced grafting. Once a master has been produced, multiple devices can be cast in PDMS quickly and easily even on a bench top. Bruin, supra; Duffy, D. C.; Schueller, O. J. A.; Brittain, S. T.; Whitesides, G. M. J. Micromech. Microeng. 1999, 9, 211-7. Another important characteristic of PDMS is its optical transparency at wavelengths >280 nm making it amenable to the use of laser-induced fluorescence detection.

Since the casting step for PDMS devices does not require access to a clean room, this methodology is accessible to a large number of investigators. The low Young's modulus and durability of PDMS make it an excellent choice for fabrication of pumps and valves. Hosokawa, K.; Maeda, R. J. Micromech. Microeng. 2000, 10, 415-20. PDMS has also been utilized in the “rapid prototyping” of devices designed for electrophoretic separations.

Despite its versatility, a number of characteristics have limited the use of PDMS in the fabrication of microfluidic devices. These limitations are most pertinent to the biological analyses for which these devices are predicted to be of great utility. Foremost among PDMS's disadvantages is its extreme hydrophobicity. This property makes wettability difficult, creating problems filling micron-sized channels with suitable aqueous buffers. Additionally, many analytes show significant adsorption to PDMS surfaces and some even penetrate into the polymer matrix itself. Unger, M. A.; Chou, H. P.; Thorsen, T.; Scherer, A.; Quake, S. R. Science 2000, 288, 113-6. This adsorption leads to sample loss, diminished resolution such as signal to noise ratio, and upper limitations on the size of separation chambers used in miniaturized analytical separations. Strong electroosmotic fluid flow (EOF) can occur in PDMS-devices, but the surface must be oxidized to support a significant EOF. EOF in the oxidized devices is unstable making reproducible eletrophoretic separations challenging. Because of these drawbacks, previous attempts have been made to tailor surface properties of polymers using both chemical and physical modifications. Duffy, D. C.; McDonald, J. C.; Schueller, O. J. A.; Whitesides, G. M. Anal. Chem. 1998, 70, 4974-84; Ocvirk, G.; Munroe, M.; Tang, T.; Oleschuk, R.; Westra, K.; Harrison, D. Electrophoresis 2000, 21, 107-15.

Recent descriptions of modifications of PDMS have been stimulated by its growing popularity in the manufacture of microfluidic devices for bioassays. Exposure of the PDMS surface to plasma oxidation renders the surface hydrophilic by ionization of silanol groups. This treatment improves wettability and supports a strong EOF for electrokinetic pumping provided the surface remains in contact with neutral or basic solutions. However, oxidized PDMS reverts to its hydrophobic character within a few hours after exposure to air. Dynamic coatings, for example, polyelectrolyte multilayers of poly(styrene sulfonate) and poly(allylamine hydrochloride), have been used to selectively coat microchannels for control and stabilization of EOF. A three-layer modification of biotinylated immunoglobulin G, neutravidin, and biotinylated dextran has been developed that considerably reduced adsorption of molecules to the channel walls while maintaining modest EOF. Linder, V.; Verpoorte, E.; Thormann, W.; de Rooji, N. F.; Sigrist, H. Anal. Chem. 2001, 73, 4181-9. Regnier and coworkers published a combination of oxidation and radical polymerization to modify PDMS surfaces with C₁₈-silanes. Garbassi, F.; Morra, M.; Occhiello, E. Polymer Surfaces, 2nd ed.; John Wiley and Sons: New York, 1998; Chapters 2, 6, 7, 12. This combination gave the investigators efficient and reproducible separations of a variety of biomolecules. However, the separation of peptides and larger molecules remains problematic given the restrictions on microfluidic fluid flow and charge parameters in a polymer-based microdevice. Indeed, despite all of the most recent advances, no single method has shown to be superior for use in biological microdevices made from polymers. Of particular importance is the current inability to generate a wide variety of films that are permanent, are uniform in density, and feature selectively tailored physical parameters through the use of a low temperature process that is compatible with the polymer substrate. UV graft polymerization is highly attractive as a method for the surface modification of polymer substrates, microfluidic devices because the process has few steps, and causes little or no penetration into the bulk polymer. Chan, C. M., supra. However, in the case of PDMS an initial reaction with a photosensitizer was required before UV-grafting could be accomplished. Inoue, H.; Kohama, S. J. Appl. Polymer Sci. 1984, 29, 877-89.

### SUMMARY OF INVENTION

This invention is compositions and methods for chemically treating polymer substrates to change their chemical or physical surface properties. The invention yields advantages in the material properties of polymers frequently used in medical devices such as implants, surgical devices, ocular lenses and in analytical devices, including polymer microdevices including particularly microfluidic devices used in analyses of biological samples. The invention enables improved performance or adds functionality to all of these applications by selected chemical surface modifications of a polymer substrate. The method works by graft polymerization of the surface of a substrate polymer device with a homogenous or heterologous population of monomers. In a preferred embodiment, the monomers are polymerized under ultraviolet light with a chain transfer agent, an oxygen scavenger, and triethylamine additive (simultaneous irradiation), resulting in a uniform coating that is covalently bonded to the surface of the substrate. The UV graft polymerization is performed by immersing the polymer substrate into an aqueous solution containing an oxygen scavenger, such as NaIO₄ (0.2 to 1.0 mM), a chain transfer agent, such as benzyl alcohol (0.1% to 1.5%, wt.), triethylamine (TEA) (up to 0.8%, wt.), and the desired monomer or mixture of monomers (1% to 20% by weight). The substrate and solution are placed under an ultraviolet light source for 0.5 h to 10 h. In some embodiments, a cross-linking agent such as poly(ethylene glycol) diacrylate (DIPEG) (0 to 2%, wt.), is used to produce a hardened, impermeable graft layer and can be combined with the chain transfer agents, photo initiators, or oxygen scavengers.

The grafting techniques described herein are suitable for a wide variety of polymer substrates. The use of PDMS below is merely for illustrative purposes and is not limiting of the invention as a whole. The parameters for the polymer substrate merely require a surface that is accessible by light, a surface on which a free radical can be generated directly or indirectly by ultraviolet light, and which is chemically susceptible to attachment by the graft monomer. In most cases, the polymer substrate will have a carbon or oxygen from which the free radical is generated. (See FIG. 1 below). The carbon or oxygen atom may be part of the polymer molecule from which the substrate is formed, or may be the result of atomic bombardment of the substrate surface. Of course, the selection of the substrate depends on the physical and chemical parameters of the intended application. For the ocular lens embodiment described below, the polymer substrate must be transparent, biocompatible for interaction with the surface of the eye, and oxygen permeable. Together with the graft polymer of the invention, an appropriate polymer substrate for an ocular lens must also have a low friction coefficient. The parameters desirable for a polymer substrate in the microfluidic devices described below include the ability to tailor the surface of selected sites in the substrate for fluid transfer, analyte separation, and detection of the analyte on the substrate. In different applications, the substrate must be susceptible of isolating compounds, such as DNA, RNA, proteins, hormones, enzymes, or other biochemical analytes for analysis by mass spectroscopy, fluorescent, illuminescent, or other detection, or chemical properties such as conductivity or binding ability to a distinct reagent.

The procedures described below work for many different homogenous or heterologous monomer grafts and for many different bulk polymer substrates with little modification. Suitable monomers include, but are not limited to, poly(ethylene glycol) (PEG), monomethoxyl acrylate (PEG), hydroxyl ethyl methacrylate (HEMA), dimethylacrylamide (DMA). The resulting polymer surface can be highly functionalized according to the needs of the device, depending on the monomers chosen and the thickness of coating applied. Interfacial properties such as hydrophobicity, surface charge, and adsorption or adhesion affinity can be modified to suit the needs of the device. The method is simple, safe, low cost, reproducible, and easily scaled to large volume manufacturing.

Additionally, mixed monomers with and without cross-linking agents are applied to a polymer substrate to yield a coating capable of fast, high quality separations of biologically relevant molecules. The surface properties of polymerized coatings comprised of a single neutral monomer (PEG), a neutral and a negative monomer (PEG:AA), or a neutral, negative, and cross-linking monomer (PEG:AA:poly(ethylene glycol) diacrylate) (DiPEG)) are evaluated by measuring the polymer graft density, the contact angle of a water droplet, and the electroosmotic mobility (μₑₒ) of coated microchannels. To demonstrate the principal of the invention, several test analytes of biologic significance are utilized to evaluate the ability of the surfaces to efficiently separate analytes. The test set of peptides are substrates or products of kinases and phosphatases which are frequently used to assay the activity of these enzymes. Measurement of the theoretical plates and the reproducibility of the migration times and peak areas of analytes demonstrated the superiority of the cross-linked coatings compared to the other surveyed polymer coatings. Cross-linking the polymer coating on PDMS enhances the separations by decreasing analyte penetration into the coating and consequently decreasing analyte-PDMS interactions.

This invention enables the surface properties of the polymer substrate to be finely tuned by: (1) copolymerizing mixtures of different monomers onto the surface, (2) controlling the degree of cross-linking of the polymers on the surface, (3) controlling the graft density and charge density simultaneously, (4) varying the identity and/or concentration of the chain transfer agent to control the polymer chain length, (5) employing multiple levels of treatment one after the other. The surface properties of polymerized coatings composed of a single neutral monomer (PEG), a neutral and a negative monomer (PEG:AA), or a neutral, negative, and cross-linking monomer (PEG:AA:poly(ethylene glycol) (DiPEG)) are evaluated by measuring the polymer graft density, the contact angle of a water droplet, and the electroosmotic mobility (μₑₒ) of coated microchannels. Several test analytes of biologic significance demonstrate the ability of the surfaces to efficiently separate analytes. The test set of peptides are substrates or products of kinases and phosphatases which are frequently used to assay the activity of these enzymes. Measurement of the theoretical plates and the reproducibility of the migration times and peak areas of analytes demonstrated a preference for the cross-linked coatings compared to the other surveyed polymer coatings. Cross-linking the polymer coating on PDMS is likely to enhance the separations by decreasing analyte penetration into the coating and consequently decreasing analyte-PDMS interactions.

The invention has tremendous value to the field of bioengineering and polymer engineering. Polymer devices, typically built for biomedical applications, have a great need for custom surface properties. Many such devices are designed to manipulate biological fluids and reagents to perform chemical or biochemical reactions in a chip-based format when the surface chemistry of the chip is critical to the performance of the device. This surface treatment can render a hydrophobic surface hydrophilic during the chip manufacturing to aid in fluid loading and handling. Surface charge can be modified to improve or diminish electro-osmotic flow, and improve electrophoresis separation. Adsorption affinity can be modified to prevent or enhance bimolecular adsorption and biofouling. Many other properties may be modified, depending on the choice of monomers used in the process. Since the process is compatible with photolithography, the properties may also be patterned for added functionality. For polymer microsystem devices, the procedure can be used to create surfaces that bond readily, reduce stiction, reduce or increase friction, protect the bulk, provide chemically active surfaces for chemical sensors, provide thin structural polymer materials, provide adhesive material, or provide optical cladding of desired refractive index.

The method described in this invention provides a means for permanently modifying the surface of polymers through covalent bonding and cross linking of the graft molecules to the surface. The resulting coating is of high density (controllable) and very uniform. The process is a one-step procedure that significantly simplifies the procedure.

The method enables a large variety of chemical properties, notably interfacial properties such as hydrophobicity, surface charge, and adhesion affinity of biomolecules, to be permanently, but selectively conveyed to a polymer surface. Therefore, the areas of graft polymerization onto a polymer substrate can be selectively controlled and localized depending on the intended application. For an ocular lens, the preferred embodiment is to create a substantially uniform polymer graft over the entirety of the polymer substrate, which is the basis component of the contact lens. In contrast, for a polymer-based fluidic microdevice, the surface treatments according to the present invention may be highly localized such that individual regions are created on the microdevice for fluid transport, charge separation, adsorption separation, or any other physical or biochemical parameter as desired. The method works the same way with a variety of monomers making it a very general purpose procedure for treating polymer devices. In particular, the ability to permanently modify the surface of a polymer microfluidic device is of great importance since most microfluidic devices require a modified surface in order to achieve high performance in applications such as lab-on-a-chip and analytical microdevices. Microfluidic devices made from many polymers can be coated without the need for exposure to high temperatures, vacuums, plasmas and oxidizers. The high level of control afforded by the process allows the manufacture of quality films of precise thickness with excellent uniformity, which is a crucial element for the fabrication of polymer microdevices. The permanent nature of the coating eliminates the need to perform dynamic coating in order to achieve high performance in microfluidic devices. Furthermore, this process is successfully producing surface treatments on polymers that are traditionally difficult to modify, such as poly(dimethylsiloxane) or silicone rubber.

As described below, the coatings applied to polymer biomedical devices can alter the surfaces in order to make them biocompatible, or of specific functionality as needed by the application. Examples of biomaterial applications include making polymer surfaces with specific charge (for electrophoresis chips), polymer surfaces with specific hydrophobicity (for lab-on-a-chip), polymer surfaces with limited biofouling (for biomedical devices), polymer surfaces with reduced friction (for catheters). In polymer engineering applications, the invention can be used to promote polymer surface adhesion (for polymer bonding or painting), to promote wettability (for environmental applications), to promote surface durability (for industrial applications). In integrated polymer microdevices, the invention may be used to grow thin polymer films (for surface micromachining applications), to grow bonding layers (for layer-to-layer bonding), to grow optical layers (for optical microdevices), and to grow dielectric layers (for electronic or microwave applications). Thus, the invention includes both the manufacturing process and the product having a graft polymer applied to substrate in any of bio-adhesives, sutures, surgical dressing, heart valve tubular devices, soft-tissue replacement materials for surgical reconstruction, drug-delivery implants, interocular and contact lenses, bone cement, joint reconstruction, tendons, blood bag, catheters, tubing, artificial lung/heart/kidney/pancreas delivery systems, polymer-based microdevices, particularly those relating to the biotech industry such as lab-on-a-chip, capillary electrophoresis chips, separation chips, biosensor, environmental sensors, biochemical reactors, sample preparation chips, bioarrays (DNA, antibody, protein), biochemical devices and immunochemical assay chips.

### DESCRIPTION OF FIGURES

FIG. 1. (I) and (II) Reaction scheme for UV-graft polymerization on a PDMS surface. Step I illustrates the formation of radicals on the PDMS surface by UV light. Step II displays the initiation step in the polymerization reaction. R is the monomer-side group.

FIG. 2. Effect of UV-exposure time on the graft density. The concentration of the monomers (closed square, PEG; open square, DMA; closed circle, HEA; open circle, AM; triangle AA) is 10% (by weight). The data points are the average of two experiments, i.e. two grafted films.

FIGS. 3A-3C. Measurement of the infrared absorbance and contact angle of grafted PDMS. PDMS films are grafted with monomer (10% by weight) by exposure to ultraviolet light for 3 h. FIG. 3A: The dashed, solid, and dotted lines are films grafted with AA, HEA, and PEG, respectively. The y axis is the infrared absorbance measured by ATR. FIG. 3B: The dashed and solid lines are films grafted with DMA and AM, respectively. The y axis is the infrared absorbance measured by ATR. FIG. 3C: The role of the UV-exposure time on the contact angle of a droplet of water is measured. The monomers are PEG (closed squares), DMA (open squares), HEA (closed circles), AM (open circles), AA (triangles). The data points are the average of two experiments.

FIGS. 4A and 4B. Measurement of the magnitude and stability of μₑₒ for grafted PDMS. The two halves of a PDMS device are grafted with monomer by exposure to ultraviolet light for 3 h. The monomers are PEG (closed squares), DMA (open squares), HEA (closed circles), and AM (open circles). FIG. 4A: The effect of graft density on the magnitude of μₑₒ is measured. The graft density is varied by changing the concentration of the monomer and benzyl alcohol. At a graft density of 60 μg/cm², the monomer concentration is 30% for PEG, 20% for DMA, 15% for HEA, and 15% for AM. FIG. 4B: The magnitude of μₑₒ is measured after exposure of HEA-grafted (circles) or oxidized (triangles) PDMS to air. After fabrication of the channels, μₑₒ is measured immediately and the devices are filled with water and stored in water. After the second measurement of μₑₒ at 5 hours, the channels are filled with air and stored in air. After all subsequent measurements of μₑₒ, the channels filled with air. For (A) and (B) the data points are the average of two experiments.

FIGS. 5A-5C. Electrophoresis on oxidized-PDMS and PEG-grafted-PDMS devices. FIG. 5A: Shown is a schematic of the channels on the microfluidic devices. FIG. 5B: The two halves of a PDMS device are grafted with PEG (10%) by exposure to UV light for 3 h. F-PKC is injected from the double “T” (v-vi) into the main electrophoresis channel (vi-iv) and electrophoresed. Shown is the electropherogram. FIG. 5C: Conditions are identical to that in (B) except that the channels are oxidized by exposure to an oxygen plasma. Also shown is the electropherogram.

FIGS. 6A-6B. schematic of the channel layout and photograph of peptide adsorption on PEG:AA-grafted channels. (6A) Shown are the four reservoirs and the injection and separation channels. The injection channel resides between reservoirs ii and iii while the separation channel connects reservoirs i and iv. Samples are loaded into reservoir ii and electrophoresed into reservoir iii. For separation of the sample, a plug was pinched off into the separation channel and electrophoresed towards reservoir iv. The fluorescence of analytes is measured just prior to reservoir iv. The square with dotted lines is the region viewed in FIGS. 6B and 11A-D. (6B) Fluorescence image of a microdevice grafted with PEG:AA after its use for the separation of F-PKB (10 μM) and F-calc (10 μM). After separation of the peptides, the channel is washed extensively with water. The white dotted lines approximate the walls of the channels. The PDMS is grafted with PEG:AA (20:1, 10% total monomer concentration).

FIGS. 7A-7C. Electrophoresis of F-src and F-PKB in channels grafted with PEG, PEG:AA, or PEG:AA:DiPEG. (7A) Elecrophoresis in a channel grafted with only PEG (10% (weight of monomer/weight of final solution)). The field strength is 600 V/3.5 cm. The concentration of the peptides in the injection channel is each 10 μM. (7B) Electrophoresis in a channel grafted with PEG:AA (98:2 (weight:weight) and 10% total monomer (weight of all monomers/weight of final solution)). The initial peak (220 s) is due to F-PKB and the second peak (240 s) was that of F-src. The peaks were identified by electrophoresing each peptide alone. Other conditions were identical to (7A). (7C) Separation in a channel grafted with PEG:AA:DiPEG (98:2:3 and 10% total monomer). Again the initial peak (66 s) is due to F-PKB and the second peak (96 s) was F-src. Other conditions were identical to (7A).

FIGS. 8A-8C. Electrophoresis of F-src and F-calc in channels grafted with PEG, PEG:AA, or PEG:AA:DiPEG. (8A) F-src (1 μM) and F-calc (2 μM) are electrophoresed in a channel coated with PEG (total monomer concentration of 10%). The separation field strength is 1000 V/3.5 cm. (8B) Separation in a channel coated with PEG:AA (20:1 (weight:weight), total monomer concentration of 10%). The conditions are identical to (A). The peak at 73 s is F-src and that at 127 s is F-calc. The peaks are identified by electrophoresing each peptide alone. (8C) Separation in a channel coated with PEG:AA:DIPEG (20:1: 1, total monomer concentration of 10%). The conditions are identical to (A) except that the surface was grafted with PEG:AA:DIPEG (20:1: 1, total monomer concentration of 10%) and the concentration of F-src and F-calc is 1 μM each. The initial peak (49 s) is due to F-src and the second (81 s) to F-calc.

FIG. 9. Effect of the concentration of DiPEG on graft density. The ratio of DiPEG to PEG (weight of DiPEG/weight of PEG) is varied and the graft density is measured. The ratio of PEG:AA is maintained at a constant ratio of 20:1. The total concentration of monomers is also constant at 10%. In this instance a 100 W mercury lamp is used for irradiation rather than a 200 W lamp.

FIGS. 10A-B. Photographs of PDMS grafted with PEG:AA:DiPEG. (10A) Shows a PDMS slab grafted with PEG:AA:DiPEG at a ratio of 20:1:1 (10% total monomer concentration). The PDMS slab remains transparent and flexible. (10B) Shows a PDMS slab grafted with PEG:AA:DiPEG at a ratio of 20:1:4 (10% total monomer concentration). The PDMS slab is no longer transparent and has become twisted and stiff.

FIGS. 11A-D. Fluorescent images of the injection and separation of F-src and F-calc on a device grafted with cross-linked PEG:AA. The conditions are identical to that of FIG. 2C except that the integration time was 100 ms with one frame acquired every 200 ms and the concentration of the peptides was 10 μM each. The images in (11A), (11B), (11C), and (11D) represent sequential frames from the CCD camera. In (11A) at 0 ms, the analytes occupy only the injection channel. At the intersection of the injection and separation channels, fluid from the separation channel enters the injection channel, sheathing and narrowing the analyte stream. In (11B) at 200 ms, the plug has begun to pinch from the main analyte stream to enter the separation channel. Panel (11C) shows the two analytes partially separated in the separation channel at 400 ms. In addition the sheathed analyte stream has completely pulled back towards reservoir iii with no residual staining of that portion of the injection channel. The main analyte stream in the injection channel has begun pulling back towards reservoir ii but remains in view. In (11D) at 600 ms, F-src and F-calc are completely separated and the main analyte stream in the injection channel continues to slowly pull back towards reservoir ii.

FIG. 12. Separation of five peptides. Separation of five peptides in a microchannel grafted with PEG:AA:DiPEG. A mixture of five peptides (F-PKB (2 μM), PF-PKB (0.5 μM), F-src (4 μM), F-calc (20 μM) is loaded into the injection channel and a plug loaded into the separation channel. The electric field strength for the separation channel is 250 V/3.5 cm. The peak labels are 1 (F-PKB), 2 (PF-PKB), 3 (F-src), 4 (PF-calc), and 5 (F-calc). The peaks are identified by electrophoresing each peptide alone. The channel was grafted with a mixture of PEG:AA:DIPEG (20:1:1, 10% total monomer).

### DETAILED DESCRIPTION OF INVENTION

The following examples are particularly preferred embodiments of the present invention, including data demonstrating the proof of principal for specially tailored surface modifications whereby surface chemistries are selectively altered for a particular polymer substrate. As described elsewhere herein, a principal advantage of the invention is the ability to tailor the modification of the surface chemistry of a polymer substrate according to the intended use. Thus, the surface modification for different biomaterials will depend on the particular requirements of the selected application. For example, the desired physical parameters of a polymer surface applied to an intravenous medical catheter will differ from the ideal parameters for a contact lens, which in turn, will differ from the desired parameters for a fluidic microdevice for electrophoresis. The present invention enables one of ordinary skill in the art to tailor the physical parameters of the surface polymer according to desired value for parameters such as graft/charge density, hydrophobicity, surface charge, adhesion affinity, permeability, and friction coefficients. Those of ordinary skill in the art will understand, in accord with the following description, that modifications to the polymer substrate, the surface coatings, and process parameters, such as ultraviolet radiation exposure, selection of cross-linking agents, selection of chain transfer agents, and selection of time of exposure will yield different results in the graft polymerization process.

The following reagents are used in the methods described herein. Sylgard 184 is purchased from Dow Corning (Midland, Mich.) and silicon nitride-coated silicon wafers are obtained from Wafernet Inc. (San Jose, Calif.). Acrylic acid (AA), acrylamide (AM), dimethylacrylamide (DMA), 2-hydroxyl ethyl acrylate (HEA), poly(ethyleneglycol) monomethoxyl acrylate (PEG), and benzyl alcohol are all obtained from Aldrich, and used without further purification. All fluorescent reagents are available from Molecular Probes (Eugene, Oreg.). Peptides are synthesized by the Beckman Peptide and Nucleic Acid Facility at Stanford University (Stanford, Calif.) and labeled with fluorescein as described previously. Lee, C. L.; Linton, J.; Soughayer, J. S.; Sims, C. E.; Allbritton, N. L. Nature Biotech. 1999, 17, 759-62. For use in the electrophoresis examples described below, the peptide sequences are fluorescein-Arg-Phe-Ala-Arg-Lys-Gly-Ser-Leu-Arg-Gln-Lys-Asn-Val (F-PKC) and fluorescein-Ala-Glu-Glu-Glu-Ile-Tyr-Gly-Glu-Phe-Glu-Ala-Lys-Lys-Lys-Lys (F-src). House, C.; Kemp, B. E. Science 1987, 238, 1726-8; Nair, S. A.; Kim, M. H.; Warren, S. D.; Choi, S.; Songyang, Z.; Cantley, L. C. F-PKB (Fluorescein-GRPRAATFAEG) [22], PF-PKB (Fluorescein-GRPRAA(T-PO₃)FAEG), F-calc ((Fluorescein-DLDVPIPGRFDRRVSVAAE) [Richey, T.; Iwata, H.; Oowaki, H.; Uchida, E.; Matsuda, S.; Ikada, Y. Biomaterials 2000, 21, 1057-65. Uchida, E.; Uyama, Y.; Ikada, Y. J. Polymer Sci.: Pt. A 1989, 27, 527-37], PF-calc (Fluorescein-DLDVPIPGRFDRRV(S—PO₃)VAAE). All other reagents and materials are available from Fisher Scientific (Pittsburgh, Pa.).

Microfluidic channel patterns and the corresponding master are designed and fabricated as described previously. Ren, X., Bachman, M., Sims, C. E., Li, G. P., Allbritton, N. L. J. of Chromat. B. 2001, 762, 117-25. Sylgard 184 PDMS prepolymer is mixed thoroughly with its cross-linking catalyst at 10:1 (wt) and degassed by vacuum for 30 minutes. The polymer or polymer mixture is cast against the silicon mold and polymerized at 70° C. for 1 hour. After curing, the PDMS is peeled from the mold and holes (3.5 mm diameter) are punched into the polymer to create access ports and reservoirs. Reservoirs above the holes are created by gluing plastic cylinders (cut from pipette tips). The reservoir volume is approximately 50 μl. Flat PDMS substrates are obtained by casting the polymer mixture on a clean, flat surface. Final polymerization of the PDMS is performed by placing the pieces in a 65° C. oven overnight.

The micromolded PDMS is sealed against a flat, PDMS substrate. In some instances, the unmated PDMS halves are placed in an oxygen plasma for 55 s (50 W at 60 mTorr). When joined together the oxygen plasma-treated parts seal irreversibly. Alternatively, the two PDMS halves may be grafted with a polymer as described in the next section and then mated. Glass cover slips support the final PDMS device.

The surface graft polymerization process is performed as follows. Micromolded or flat PDMS films are immersed in an aqueous solution containing NaIO₄ (0.5 mM), benzyl alcohol (0.5% by weight), and monomers at the indicated concentrations and ratios. The solution for immersion can also be a suitably organic solvent in which the monomers are miscable and assuming that the solvent is compatible with the polymer substrate on which the graft is placed. The benzyl alcohol is a preferred chain transfer agent that functions to terminate excessive polymerization in solution and to enhance the quality and physical parameters of the graft polymer. In an IO4 is an oxygen scavenger that prevents excessive free radical formation in the monomer solution. The immersed films are placed in a custom-built irradiator (200 W mercury lamp) for the times indicated. In a particularly preferred embodiment, the wavelength of the ultraviolet light is below 400 nm. The 200 W mercury lamp has a glass component that filters the spectrum of radiation to yield mostly ultraviolet light in the approximate range of 300 nm. The distance between the sample and the lamp is 5 cm. Uniform UV exposure is ensured by rotating the films under the UV source. The samples are then washed in distilled water at 80° C. under constant stirring for 24 h to remove adsorbed monomers and polymers.

To measure graft density of the dry PDMS films, they are placed under a vacuum at room temperature until the weight is stable. Dried PDMS films are weighed before and after surface grafting. The graft density is defined as the difference in the film weight before and after grafting divided by the total surface area of the film.

Infrared absorption is measured by total attenuated reflection (ATR-IR). ATR-IR spectra of PDMS films on a wedged germanium crystal are recorded using a single beam spectrometer (NICOLET MAGNA-IR 860 SPECTROMETER) equipped with a helium neon laser, a TGS (triglycine sulfate) detector, and a ZnSe reflection element. Spectra are recorded at 4 cm⁻¹ resolution, and 4096 scans are collected per trace. A single-beam reference spectrum of a freshly cleaned germanium crystal is recorded before the measurements and used as the background spectrum. A water spectrum is also recorded, scaled empirically, and subtracted from the PDMS spectra to remove the water peaks in the region of 3500 cm⁻¹.

Contact angles are measured on flat PDMS films with varying surface graft densities and with or without grafted polymer. A droplet of deionized water is placed on the air-side surface of a film at room temperature, and after 30 s the contact angle is measured using a contact angle goniometer (NRL-100, Rame-Hart). The average of five measurements is utilized for each droplet.

Conventional monitoring methods are used to measure μₑₒ in the microfabricated channels. Ren, et al., supra. At least 3 measurements are performed on each device. A single straight channel 3 cm in length is used for the measurements. The channel's width at the bottom, middle, and top are 30, 60, and 75 μm. The center of the channel is 15 μm deep. To measure the stability of μₑₒ after exposure to air, the channels are flushed with water, dried under a vacuum, and then exposed to air at room temperature. At the times indicated, the channels are filled with aqueous buffer and μₑₒ is measured. After the measurement, the channels are flushed with water, dried under a vacuum, and again exposed to air at room temperature until the next measurement of μₑₒ.

### EXAMPLE 1

### Surface Grafting of Homogenous Polymer Compositions onto PDMS

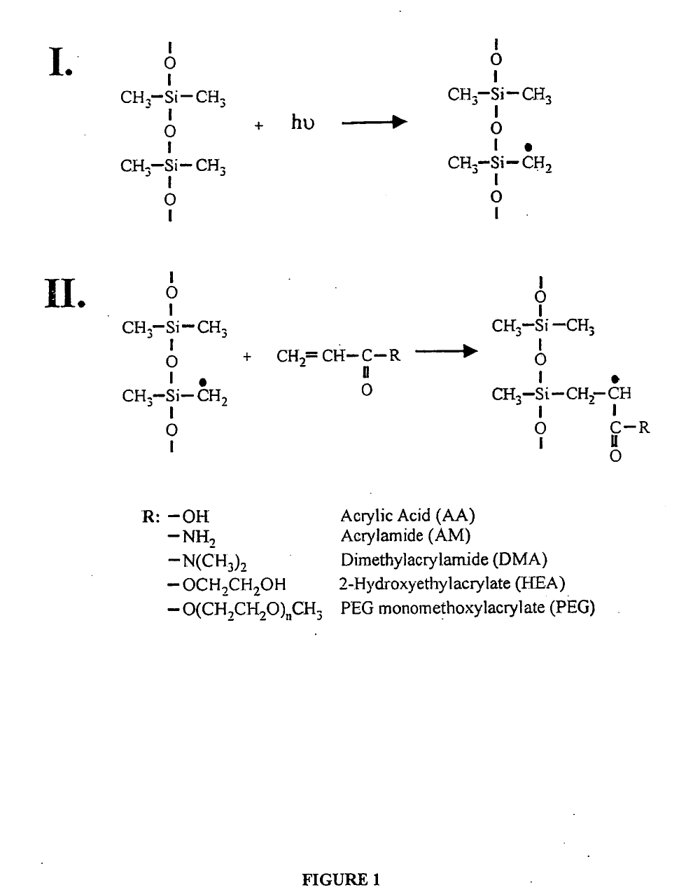

To modify the surface properties of PDMS devices a variety of monomers are UV-grafted onto the PDMS surface. With this method, attachment of polymers can be accomplished in a single step. The monomers are selected to be hydrophilic since this is an attribute of most surfaces resistant to protein adsorption (compared to hydrophobic surfaces) (19-21). The monomers, AA, AM, HEA, PEG, and DMA, are also selected based on their likely ease of attachment, past usage in biocompatible devices, and display of different functional groups. Ikada, Y. Biomaterials 1994, 15, 725-36; Belanger, M. C.; Marois, Y. J. Biomed. Mater. Res. (Appl. Biomater) 2001, 58, 467-77; Jagur-Grodzinski, J. Heterogeneous Modification of Polymers, John Wiley and Sons: New York, 1997; Chapters 7, 8. PDMS films are immersed in aqueous solutions containing the monomer and then irradiated with a mercury lamp. NaIO₄ is included in the monomer solution to scavenge oxygen which could compete with the monomer for reaction with free radicals on the PDMS surface. Uchida, E.; Uyama, Y.; Ikada, Y. J. Appl. Polymer Sci. 1990, 41, 677-87. The ultraviolet lines of the mercury lamp provide the energy to create radicals on the surface of the PDMS (FIG. 1). Chan, C. M. Polymer Surface Modification and Characterization, Hanser/Gardner Publications: Cincinnati, 1994; Chapters 1, 2, 5. It is known in the art that creation of the surface radicals initiates the attachment of the monomer to the surface which is then followed by a self-propagating chain reaction (until termination) to yield the final polymer strand. Chan, et al., supra. Initial attempts at surface grafting onto the PDMS films, however, have been unsuccessful using the above conditions. The surface density of grafted polymer on the PDMS surface is unmeasurable irrespective of the concentration of monomer or NaIO₄, or the duration of UV exposure. Under these conditions homopolymerization in the aqueous solution surrounding the film resulted in a highly viscous solution. The resulting restriction on the diffusion of reactive species to the surface may have further hindered efficient surface grafting.

The inclusion of benzyl alcohol in the monomer solution can substantially increase the efficiency of surface grafting. Richey, T.; Iwata, H.; Oowaki, H.; Uchida, E.; Matsuda, S.; Ikada, Y. Biomaterials 2000, 21, 1057-65. For the grafting of AA onto polyethylene, the efficiency of grafting is known to increase as the concentration of benzyl alcohol increased (Richey et al., supra), presumably because benzyl alcohol may act as a chain transfer agent during polymerization. Inclusion of benzyl alcohol facilitates chain termination which greatly diminishes the viscosity of the aqueous solution, enhancing diffusion of reactive monomer and polymer molecules to the PDMS surface. Addition of benzyl alcohol (10%) to the monomer/NaIO₄ solution during UV exposure greatly increased the grafting efficiency onto PDMS for all five monomers (PEG, DMA, AA, AM, and HEA).

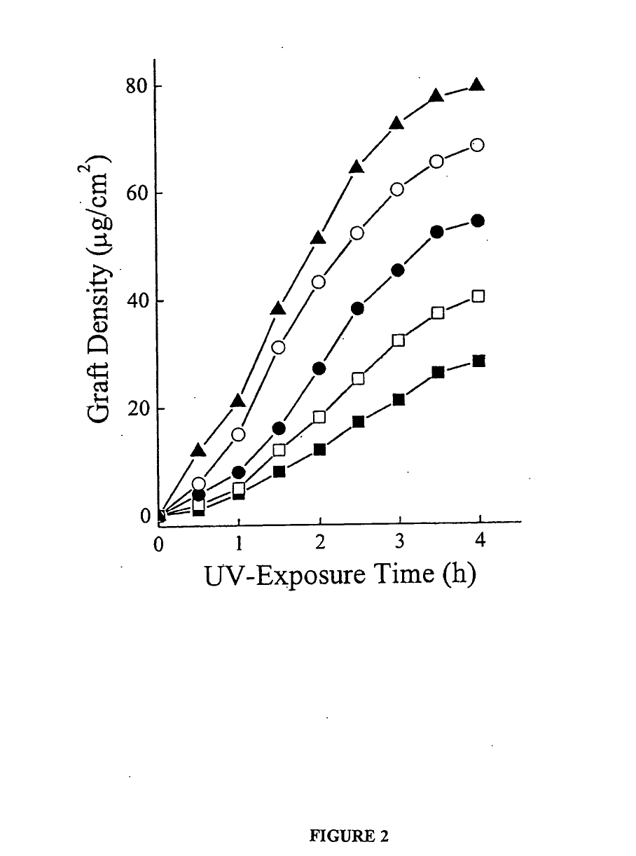

To determine the quantity of monomer grafted, the graft density is measured after exposure to ultraviolet irradiation for varying times (FIG. 2). The graft density for all monomers increased with the irradiation time; however, the rate of grafting is initially slow. This is most likely due to the time required to form sufficient numbers of radicals on the PDMS film to graft measurable quantities of monomer (either directly to the surface or as part of a growing chain). By four hours the rate of monomer addition to the films with the highest graft densities (AA, AM, and HEA) had slowed markedly probably due to increasing numbers of chain termination reactions and the filling of the available reaction sites on the films. The densities of AA, AM, and HEA are comparable to that measured for UV grafting of acrylamides onto poly(ethylene terephthalate), polypropylene, and other polymers. Lower graft densities (at a given concentration of monomer) are achieved for PEG and DMA compared to AA, AM, and HEA. Higher absolute graft densities could be obtained by increasing the monomer concentration of PEG and DMA. The lower relative graft densities of PEG may be due to the high viscosity of the PEG-containing solution. The solubility of poly-DMA in an aqueous environment decreases as the DMA chain length increases. Therefore, the lower relative graft density of DMA may be due to the exclusion of water near the surface of the PDMS as the DMA chain increased in length and degree of surface coverage. Increasing the concentration of benzyl alcohol increased the graft density for all of the monomers. At high graft densities (>100 μg/cm²) of AA, AM, HEA and DMA, the films became less transparent to light and less flexible compared to native PDMS. This suggests that the grafted layer is sufficiently thick to begin to display the bulk properties (rather than just the surface properties) of the grafted polymer.

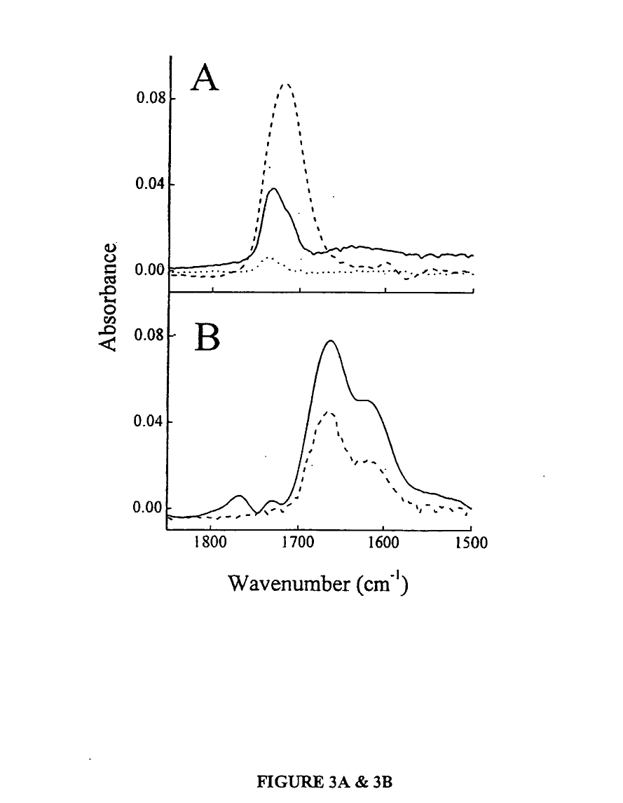

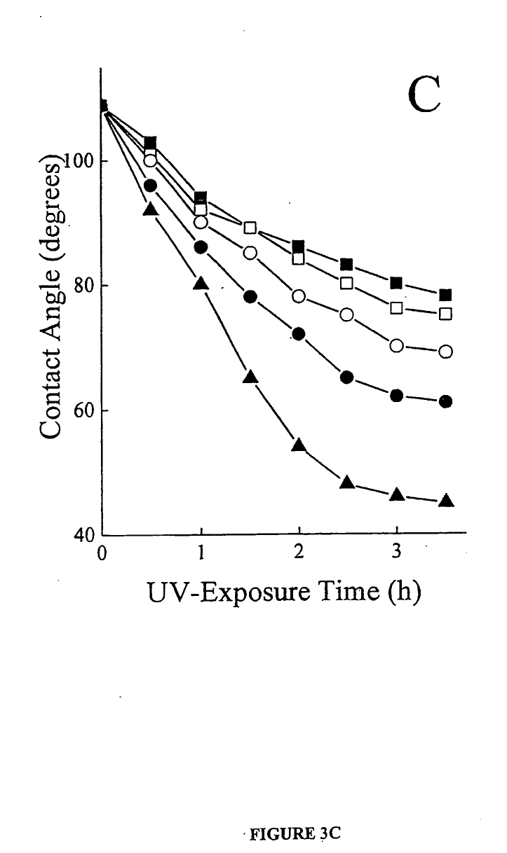

The surface properties of grafted PDMS are measured to insure that the graft exhibits the desired surface properties for the selected application. To determine whether the appropriate chemical groups are present on the surface of the grafted PDMS, the ATR-FITR spectra of the surface is measured. HEA and PEG-grafted PDMS possessed absorption maxima at 1730 cm⁻¹ which corresponds to the carbonyl adjacent to the ester group in the grafted polymers (FIG. 3A). Surfaces grafted with either DMA or AM displayed peaks centered at 1655-1660 cm⁻¹ which is due to the carbonyl groups adjacent to the amide group (FIG. 3B). PDMS surfaces grafted with AA exhibited a strong absorption at 1715 cm⁻¹ due to the carbonyl near the hydroxyl (FIG. 3A). Native PDMS displayed no absorption bands between 1800-1500 cm⁻¹ suggesting that the PDMS is successfully linked to the different grafted polymer groups.

The contact angle measurement of a water droplet is frequently used as a measure of the hydrophobicity of a surface. To follow changes in the surface hydrophobicity of the PDMS during grafting, the contact angle of a water droplet is measured after varying exposure times to the UV light. The contact angle of unmodified PDMS is 109° consistent with its high hydrophobicity. For all monomers grafted, the contact angle diminished over time reaching a minimum at approximately 3.5 hours (FIG. 3C). The relative ordering of the contact angle achieved by 3.5 hours is consistent with the density of surface grafting. For example, AA which is deposited at the highest density also produced the smallest contact angle (45°) or most hydrophilic surface. The high polarity of the AA monomer is also likely to increase the hydrophilic character of the surface as more monomers are attached. In contrast, PEG even after 3.5 hours of grafting resulted in a contact angle close to 80° and a surface more hydrophobic than any other monomer used. PEG is also deposited at the lowest density and it is possible that exposed regions of PDMS may contribute to the greater hydrophobicity of the grafted surface compared to that of the other monomers. Additionally, when compared to the other grafted groups, the polyPEG would be the more hydrophobic in nature.

To determine how the grafted polymers influenced the adsorption of biologically relevant peptides on to the PDMS surface, two fluorescently tagged peptides are spotted onto the surface of PDMS films. Both peptides are substrates for a kinase, F-PKC for protein kinase C and F-src for src kinase. These peptides are frequently used in in vitro and in vivo assays for kinase activity, and similar substrate peptides have been employed to measure kinase activity using glass and polymer microfluidic devices. Native, oxidized, and grafted PDMS films are incubated with the peptides and then thoroughly washed. The fluorescence of the films is then imaged, and the degree of peptide adsorption quantitated from the residual fluorescence. The peptides which possessed a positive charge did not adsorb to the native PDMS or the grafted PDMS surfaces (see Table I below). In contrast the peptides remained on the surface of the oxidized PDMS even after extensive washing suggesting that the peptides are very tightly adsorbed to the surface.

TABLE I
Fluorescence of PDMS Films After Adsorption of Peptide

| | PDMS Surface | | | | | |
|---|---|---|---|---|---|---|
| | | | Grafted Monomer* | | | |
| Peptide | Native | Oxidized | AM | DMA | HEA | PEG |
| F-PKC | 180 | 1100 | 290 | 320 | 480 | 200 |
| F-src | 300 | 1520 | 260 | 250 | 410 | 205 |

*The films are grafted with 10% monomer for three hours.

As described in detail in Example 6, the use of grafted polymers in a microdevice enables electrophoretic separations of analytes. To determine how the surface grafted polymers influenced the adhesiveness of the two PDMS halves of a microdevice, the top and bottom portions of a device are grafted with the monomers. At all graft densities PEG- and HEA-coated PDMS readily sealed with other like-coated surfaces. AM and DMA-grafted surfaces sealed with like surfaces only at lower graft densities (<100 μg/cm²). This is most likely due to the rigidity of PDMS films with high AM or DMA-graft densities. All surfaces that did seal, sealed reversibly suggesting that the adhesiveness is due to a noncovalent interaction. The differential adhesiveness of the different surfaces may have been due to a number of other factors in addition to the PDMS flexibility, for example, the rotational mobility of the methyl and grafted polymers about the —Si—O— backbone of the PDMS at the surface and the properties of the grafted side chains themselves.

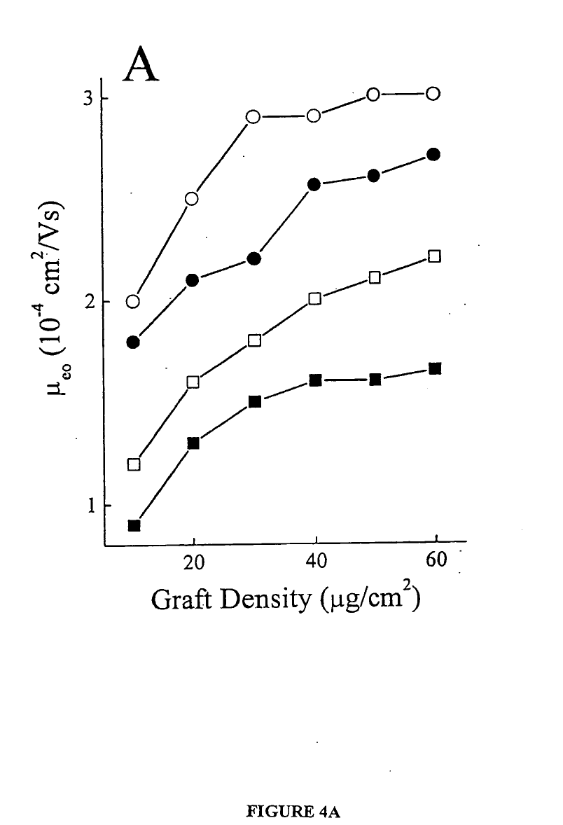

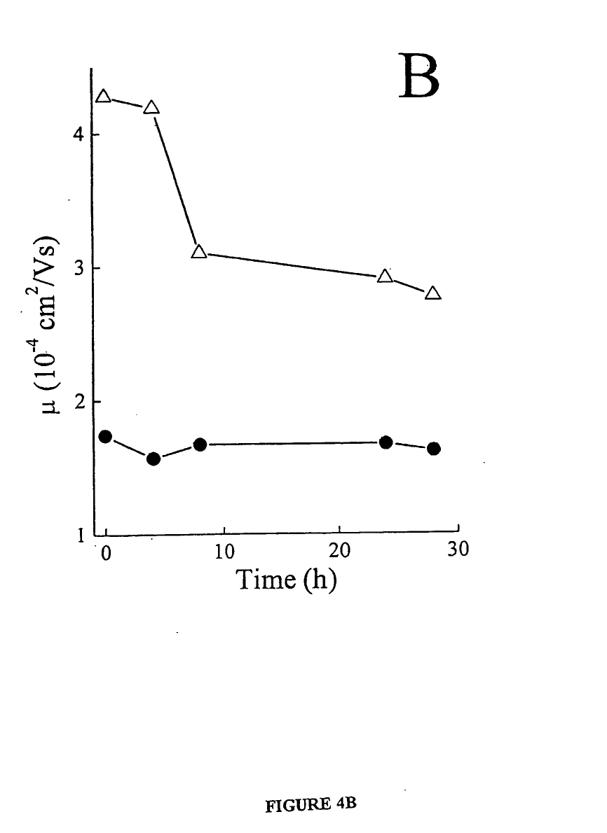

To determine how the grafted polymers altered electroosmotic fluid flow in microchannels, μₑₒ is measured in channels grafted with varying densities of the monomers. As the graft density increased, μₑₒ increased for all monomers tested (FIG. 4A). For reference μₑₒ of native and oxidized PDMS is 0.8×10⁻⁴ and 4×10⁻⁴ cm²/Vs, respectively. The increased value of μₑₒ for the grafted polymers relative to that of native PDMS is expected since these surfaces are considerably more hydrophilic than native PDMS. The increase in magnitude of μₑₒ began to plateau at graft densities near ˜30 to 60 μg/cm² suggesting that higher densities did not substantially alter the zeta potential of the surfaces. The maximum μₑₒ achieved at high densities of the AM-based polymer is ˜3×10⁻⁴ cm²/Vs. Not surprisingly μₑₒ of these polymers is always below that of oxidized PDMS which possesses substantial negative charge (4). For any given graft density, grafted PEG had the lowest μₑₒ. For a given graft density (expressed as μg/cm²), fewer numbers of PEG monomer molecules are placed on the surface compared to the other monomers (since the PEG monomer has a much higher molecular weight compared to the other monomers). This could result in less complete coverage of the surface leaving more of the hydrophobic, native PDMS exposed and consequently a lower value for μₑₒ. Alternatively, the greater hydrophobicity of the polyPEG compared to the other grafted polymers may be responsible for the lower values of μₑₒ.

A major difficulty with the use of oxidized-PDMS microchannels is the instability of μₑₒ upon exposure of the devices to air. The decrease in μₑₒ is thought to be due to the movement of hydrophobic groups to the PDMS surface either by reorientation of hydroxyl groups into the bulk and methyl groups to the surface, or the diffusion of low molecular weight PDMS from the bulk to the surface. The surfaces of other polymers can also be sufficiently dynamic so as to alter their properties in response to changes in the surrounding environment. For example, the surface of poly(hydroxyethylmethacrylate) films exposes methyl groups at polymer-air interfaces. Upon addition of water, however, the surfaces exhibit hydroxyl groups (instead of methyl groups) at the polymer-water interface. To determine the stability of the surfaces of the grafted microchannels, μₑₒ is measured at varying times after exposure to air (FIG. 4B). For the grafted devices, μₑₒ is stable for up to 30 hours (the longest time measured) irrespective of whether the devices are stored in air or water. In contrast when microchannels with oxidized surfaces are exposed to air, μₑₒ decreased by 30%.

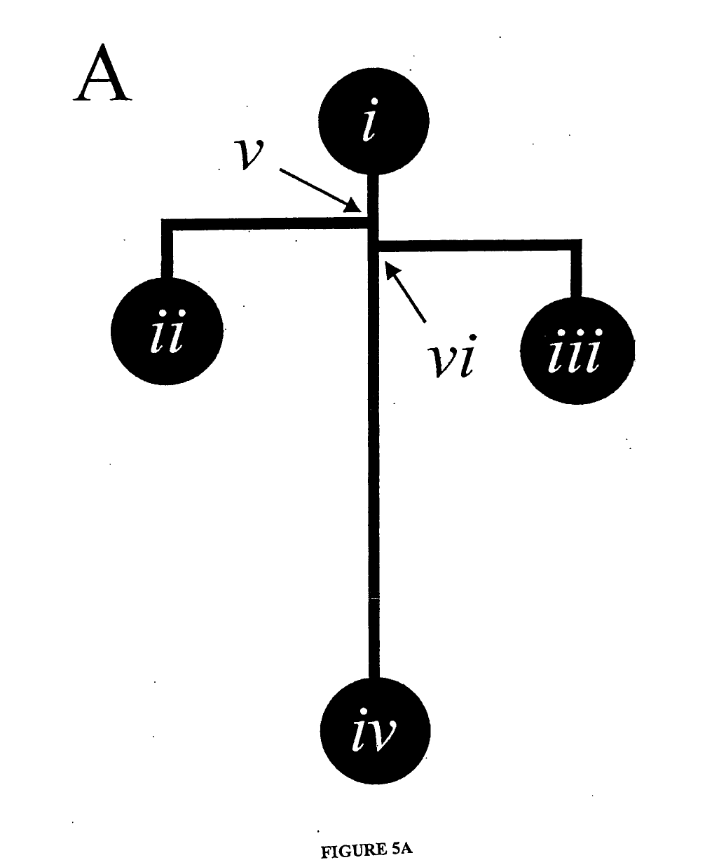

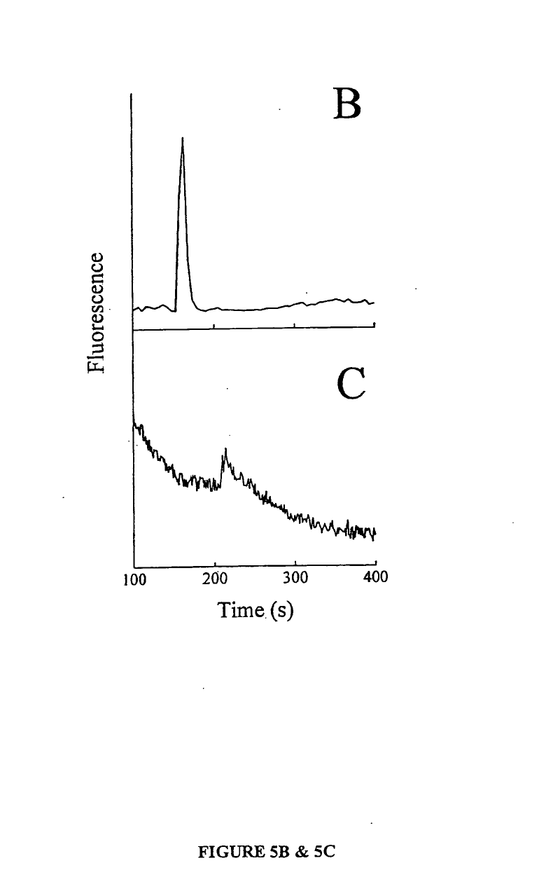

To determine whether the grafted surfaces are suitable for electrophoretic applications, a microfluidics device with a double “T” injector is constructed from PEG- and DMA-grafted PDMS as well as oxidized PDMS (FIG. 5A). Oxidized PDMS is used rather than native PDMS due to the difficulty in filling unmodified PDMS devices with aqueous buffers. F-PKC or F-src is electrophoresed in the devices and the fluorescence of the peptide is detected 2 cm from the double “T” with a CCD camera. When the peptides are electrophoresed in the oxidized PDMS channels, no or very small peaks are detected (FIG. 5C). After injection of the peptides, the channels between the sample and waste reservoirs (ii-v-vi-iii) are brightly fluorescent and remained so even after extensive washing. Following injection of a sample plug from the double “T” (v-vi) into the main electrophoresis channel (vi-iv), the main electrophoresis channel became fluorescent as the plug moved through the channel until the plug itself disappeared. Adsorption of the peptides to the oxidized PDMS is so severe that most of the sample is consumed before the sample could reach the detection zone. In contrast when peptides are injected and electrophoresed in DMA or PEG-grafted channels, the sample to waste channels (ii-v-vi-iii) are nonfluorescent when the sample is pulled back into reservoirs ii and iii. Furthermore the main electrophoresis channel (vi-iv) did not become fluorescent as the sample plug migrated through the channel and peaks are always detected at the detection window (FIG. 5B). The adsorption of the positively charged peptides is dramatically reduced in the grafted channels.

The measurable graft density and the presence of the appropriate chemical groups observed by ATR-IR illustrates the successful attachment a range of different monomers, including but not limited to AA, AM, HEA, DMA, and PEG to the surface of PDMS. For all these single species, grafting occurred only in the presence of benzyl alcohol which is thought to act as a chain transfer agent. All grafted surfaces exhibited a decrease in the contact angle of water compared to that of native PDMS. Consistent with the increased hydrophilic nature of the grafted surfaces, microchannels formed from the grafted PDMS are easily filled with aqueous solutions. At low graft densities (<100 μg/cm²), the PDMS films retained the flexibility and optical transparency of unmodified PDMS. These films also sealed reversibly so that devices constructed from them could be taken apart, cleaned, and resealed. μₑₒ for the grafted microchannels is intermediate to that of native and oxidized PDMS suggesting that the surfaces possessed a greater charge density than native PDMS but less charge density than oxidized PDMS. At high graft densities (>100 μg/cm²), some of the films became less flexible and exhibited a loss of transparency. However μmₑₒ reached a maximum at graft densities less than 60 μg/cm² suggesting that full surface coverage had been attained. Thus graft densities greater than 60 μg/cm² may only increase the depth of the polymer layer and not the extent of surface coverage. These higher graft densities may not impart any additional advantageous properties to the PDMS surfaces.

Compared to oxidized PDMS, the grafted PDMS exhibited substantially less adsorption of charged, test peptides. Also in contrast to oxidized PDMS, μₑₒ of the grafted-PDMS devices is stable upon exposure of the channels to air. The decreased adsorption and increased surface stability of the grafted PDMS make these surfaces more suitable than oxidized PDMS for many electrophoretic applications. By combining UV-mediated grafting with the appropriate monomer, a large number of different surface properties are imparted to PDMS thereby greatly increasing the utility of PDMS in the construction of microfluidic devices.

### EXAMPLE 2

### Surface Grafting of Heterologous Polymer Composition onto PDMS

As noted above, the physical parameters of a surface polymer graft may be altered to achieve selected properties in accord with the intended use of the substrate and monomer combination. For example, the use of a substrate combined with a graft comprised of mixed monomers, with and without cross-linking agents, develops fast, high quality separations of biologically relevant molecules on PDMS micro devices. In this example, the surface properties of polymerized coatings composed of a single neutral monomer (PEG), a neutral and a negative monomer (PEG:AA), or a neutral, negative, and cross-linking monomer (PEG:AA:poly(ethylene glycol) diacrylate) (DiPEG)) were evaluated by measuring the polymer graft density, the contact angle of a water droplet, and electroosmotic mobility (μₑₒ) of coated microchannels. Several test analytes of biologic significance were utilized to evaluate the ability of the surfaces to efficiently separate analytes. As in the Example above, the test set of peptides were substrates or products of kinases and phosphatases which are frequently used to assay the activity of these enzymes. Measurement of the theoretical plates and the reproducibility of the migration times and peak areas of analytes demonstrated the superiority of the cross-linked coatings compared to the other surveyed polymer coatings. Cross-linking the polymer coating on PDMS is likely to enhance the separations by decreasing analyte penetration into the coating and consequently decreasing analyte-PDMS interactions.

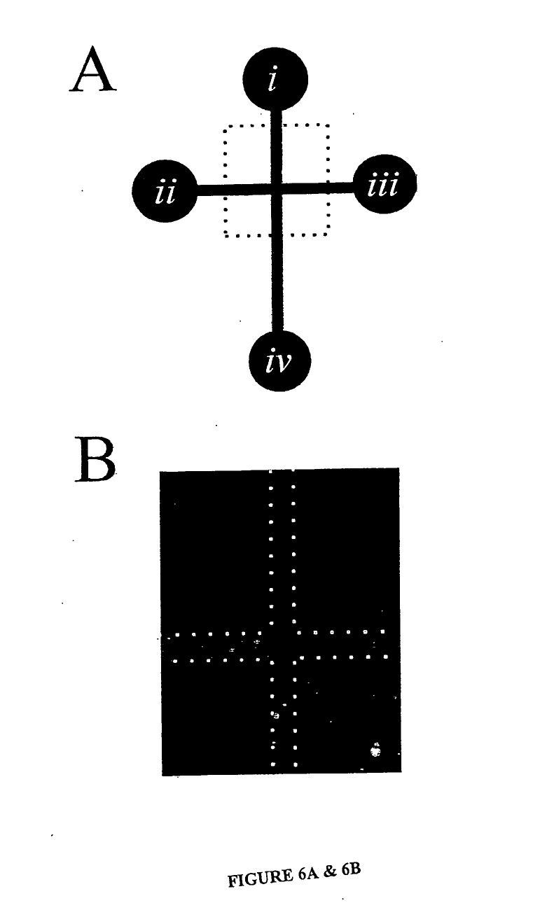

For electrophoretic injections in this embodiment of the invention, channels with a “cross” injector are used. The channels possessed curved sidewalls and are 15 micrometers deep at their center. The channel width at the bottom, middle, and top is 30, 50, and 80 μm, respectively. The length of the injection channel was 2 cm (between ii and iii of FIG. 6A); the injection channel is intersected at its mid point by the separation channel. The separation channel is a total of 3.5 cm in length (between i and iv of FIG. 6A) and was intersected 1 cm from its origin (at reservoir i) by the injection channel. All solutions are degassed by sonication for 10 min immediately prior to use. For sample injection, peptide is loaded into one of the reservoirs (reservoir ii) of the injection channel and then electrophoresed towards the opposite reservoir (reservoir iii) of the injection channel by applying 500V across the entire injection channel. During this time the separation channel reservoirs are held at 475 V (reservoir i) and 700 V (reservoir iv) to prevent sample leakage into the separation channel. The electrophoretic buffer is composed of Tris (25 mM) and glycine (192 mM) at pH 8.4. After the sample occupies the entire injection channel, the voltages applied to the reservoirs are rapidly switched to ground potential except the upper reservoir (reservoir i) which is switched to the indicated voltage. Upon rapidly switching the voltages a portion of the sample stream is pinched from the injection channel and loaded into the lower 2.5 cm of the separation channel. This voltage protocol produces a “strong-pinch” injection plug of ˜10 p1. The power supplies (Ultravolt, Long Island, N.Y.) used to control the voltages are computer-controlled by custom software (Testpoint, Keithley-Metrabyte, Taunton, Mass.). The fluorescence of the analytes is imaged 0.5 cm prior to the lower reservoir (reservoir iv) with an inverted fluorescence microscope (Nikon, 40× lens) and a cooled CCD camera (Photometrix Coolsnap FX, Tucson, Ariz.). The integration time is 1 second unless stated otherwise. The average fluorescence intensity from a 100 micron length of the channel was measured using Metafluor software (Universal Imaging Corporation, Downingtown, Pa.) and plotted over time to generate the electropherograms. All analytes were dissolved in the electrophoretic buffer.

The theoretical plates (N) are calculated from the equation:

$$N = 2 \times {π ( \frac{t \times h}{A} )}^{2}$$

where A is the peak area, h the peak height, and t the migration time.

In the Example above, microfluidic channels coated with PEG by UV grafting are shown to be suitable for the separation of two test peptides. To determine whether other analytes could be separated in these PEG-coated devices, PEG is grafted onto the top and bottom portions of a PDMS microdevice. The surface properties of the grafted PDMS (graft density and contact angle of a water droplet) are similar to that described above. The two halves of the PDMS device are sealed by manually pressing them together. In agreement with the example above, the μₑₒ of the channels was greater than that of native PDMS but substantially less than that of oxidized PDMS (Table II).

TABLE II
Surface Property of Grafted Channnels

| | | Graft | Contact | |
|---|---|---|---|---|
| | Monomer | Density | Angle | |
| Surface Coating | Ratio | (μg/cm²) | (degrees) | μₑₒ |
| PEG | — | 27 ± 2 | 82 ± 2 | 0.91 ± 0.05 |
| PEG:AA | 300 | 29 ± 2 | 79 ± 2 | 1.95 ± 0.07 |
| PEG:AA:DiPEG | 20:1:1 | 148 ± 2 | 78 ± 2 | 3.64 ± 0.08 |

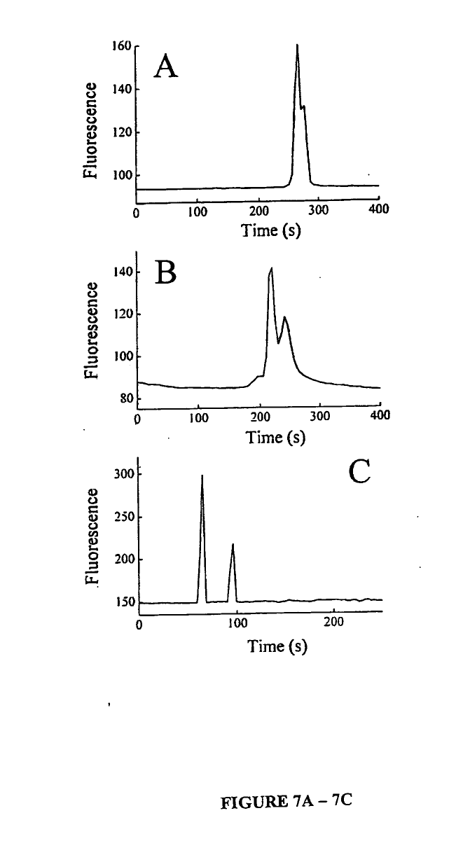

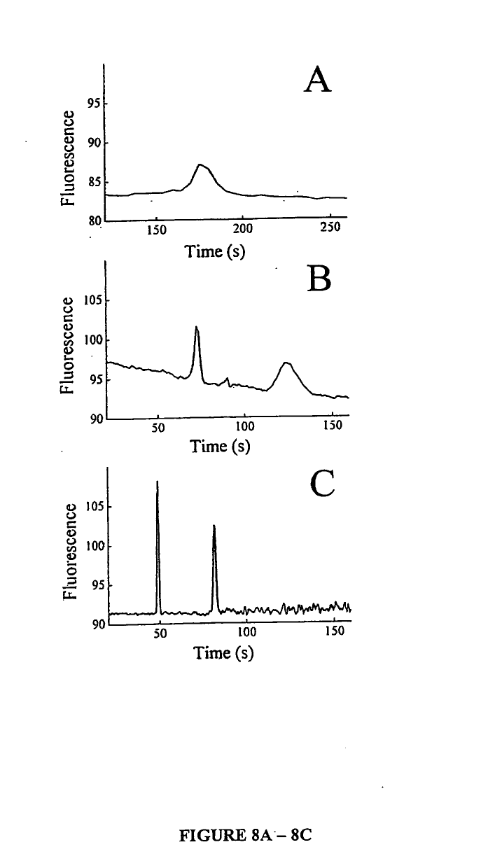

To assess the separation capability of the PEG-grafted channels, peptides that were substrates or products of kinases or phosphatases were electrophoresed in microchannels grafted with PEG. These peptides are frequently used in in vivo and in vitro assays to measure the activity of kinases and phosphatases and consequently are of great interest to the biological research community. A mixture of a substrate for src kinase (F-src) and either a product of the phosphatase calcineurin (F-calc) or a substrate of protein kinase B (F-PKB) is loaded into the injection channel of a PEG-grafted device with microchannels in a “cross” design (FIG. 6A). A plug is injected into the separation channel using a “tight-pinch” and electrophoresed 2 cm to the fluorescence detection region. When F-src is mixed with F-PKB and electrophoresed, a single bifurcated peak was observed (FIG. 7A). A variety of different buffer systems did not yield separation of the two peptides. When F-src and F-calc mixed, injected, and electrophoresed, a single broad peak was obtained (FIG. 8A). To determine whether the peptides are not separable or whether only one peptide was injected into the separation channel, a solution containing either F-src or F-calc was loaded into the injection reservoir. The intersection of the separation and injection channel was then visualized with a CCD camera as the voltage protocol for sample injection was initiated (see above). F-src migrated through the injection channel and a plug was injected into the separation channel. In contrast F-calc did not enter the injection channel upon application of the voltage protocol, due to the high negative charge of F-calc. The fluid velocity due to electroosmosis was less than the velocity of F-calc due to electrophoresis. Using the described voltage protocols, a mixture of F-src and F-calc could not be simultaneously injected into the separation channel and electrophoretically separated on the PEG-grafted PDMS devices. In addition the migration time reproducibility, peak area reproducibility, and the number of theoretical plates for the F-src peak were poor (Table III). For these peptide analytes, microchannels grafted solely with PEG did not yield adequate resolution or separation efficiency.

TABLE III
Electrophoresis of Peptides in Grafted Microchannels^{a}

| | | | | | Number of |
|---|---|---|---|---|---|
| Peptide | PEG:AA:DiPEG^{d} | Theoretical Plates | Peak Area | Migration Time | Devices |
| F-src^{b} | 20:0:0 | 753 + 253 | 58 + 15 | 174 + 33 | 3 |
| F-calc^{b} | 20:0:0 | No Peak | | | 3 |
| F-src^{b} | 20:1:0 | 2289 + 297 | 28 + 3 | 73 + 1 s | 3 |
| F-calc^{b} | 20:1:0 | 525 + 73 | 59 + 6 | 127 + 4 s | 3 |
| F-src^{c} | 20:1:1 | 18643 ± 2206 | 21 ± 1 | 49 ± 1 s | 5 |
| F-calc^{c} | 20:1:1 | 12116 ± 1332 | 23 ± 3 | 82 ± 1 s | 5 |

^{a}Shown are the average of the measurements ± their standard deviation. The electrophoretic conditions were identical to that of FIGS. 8A-8C.
^{b}The concentration of F-src was 1 μM while the concentration of F-calc was 2 μM.
^{c}The concentration of F-src was 1 μM while the concentration of F-calc was 1 μM.
^{d}The total concentration of monomer (weight of all monomers/weight of final solution) was 10%.

### EXAMPLE 3

### Electrophoretic Separations on Microchannels Grafted with Co-Mixed PEG and AA

Since the homogenous PEG-grafted microchannels do not yield acceptable separations of the test peptides, the PDMS halves of a microchannel are grafted with a mixture of PEG and AA. In addition to altering the separation properties, the additional AA in the composition increases the EOF permitting F-calc to be injected into the separation channel. The two halves of a PDMS device are grafted with a mixture of PEG and AA. The graft density of the surface is nearly the same as that when PEG was grafted alone (Table II). In addition the contact angle of a water droplet on the PEG:AA-grafted surface was only slightly decreased compared to that of a PEG grafted surface (Table II). Since PEG is very hydrophilic, the additional AA does not substantially alter the hydrophilicity of the surface. The two halves of the PEG:AA grafted surface are easily sealed by manual pressure. In contrast to the graft density and contact angle, the magnitude of μₑₒ is substantially increased by the addition of the AA to the surface (Table II). AA is negatively charged at pH 7.0 (the pH of the buffers used for μₑₒ measurement). Thus, the AA contributes substantial charge compared to that from the PEG which is not ionized at pH 7.0.

A mixture of F-src and F-PKB is loaded into the injection channel and a plug pinched off into the separation channel of a device grafted with a mixture of PEG and AA. The two analytes still are not completely resolved although the separation was improved compared to that in a channel grafted only with PEG (FIG. 7B). To determine whether F-src and F-calc are separable in the PEG:AA-grafted channels, a mixture of these two peptides is loaded into the injection channel and a plug pinched and electrophoresed. Two fully resolved peaks are present on the electropherogram (FIG. 8B); however, both peaks are broad with a low number of theoretical plates (Table III). The reproducibility of the peak area and migration times for both the F-src and F-calc peaks are greatly improved relative to that of F-src on the PEG-grafted devices. A large number of different PEG:AA ratios were tested as grafted coatings but none yielded better resolutions. To determine why the number of theoretical plates might be low, a PEG:AA-grafted device which was utilized to electrophorese F-src and F-calc is rinsed and then photographed using a fluorescent microscope. Residual fluorescence is clearly visible in the channels suggesting that either or both of the peptide analytes had adsorbed to the channels walls during the course of the experiments (FIG. 6B).

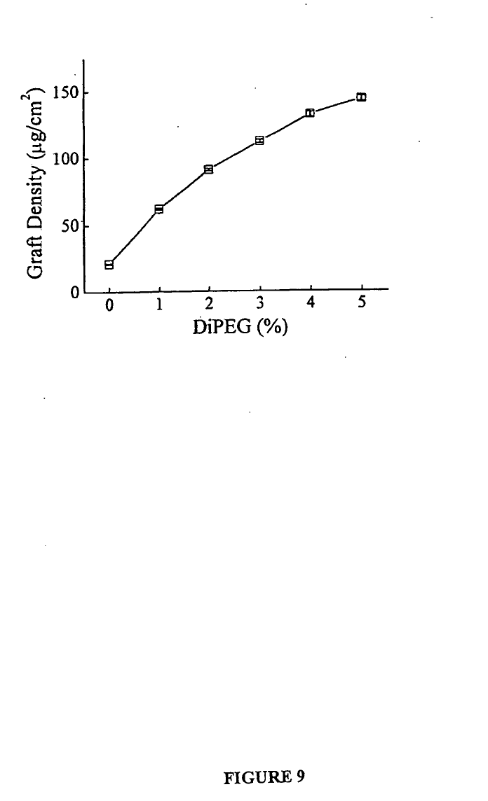

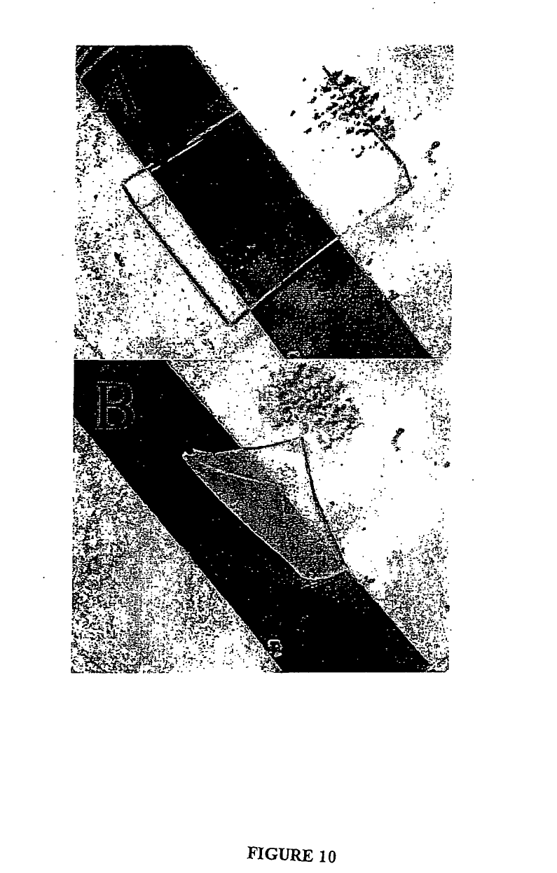

Characterization of PDMS surfaces grafted with PEG, AA, and DiPEG. Since the PDMS surfaces grafted with PEG and AA exhibited visible analyte absorption and do not yield acceptable separations, the analytes appear to interact with the underlying PDMS due to incomplete polymer coverage or an inability of the small analytes to migrate through the polymer strands. Either situation enables the analytes to interact with and potentially adsorb onto the PDMS. The cross-linking of surface-attached polymers with a variety of agents has been shown to improve coverage of surfaces and has been used extensively to improve electrophoretic separations. Horvath et al., Electrophoresis, 2001, 22, 644-655. Cross-linking is also widely used to “harden” polymer coatings reducing the ability of other molecules to penetrate into the coating. Stevens, M. P., Polymer Chemistry, 3d Ed., Oxford University Press, New York, 1999. For this reason the grafted polymers were cross-linked with poly(ethylene glycol) diacrylate (DiPEG) to determine whether higher graft densities or better coverage of the PDMS could be attained. DiPEG is added to the PEG:AA mixture prior to UV grafting. At a constant concentration of AA and PEG, the graft density increases as the concentration of DiPEG was increased (FIG. 9). Addition of as little as 1% DiPEG yields a four-fold increase in graft density (from 15 to 60 micrograms/cm2). This dramatic increase suggests that in addition to cross-linking surface-attached polymer chains, the DiPEG itself probably also reacts with the polymer substrate surface. In addition, the DiPEG may have cross-linked polymer chains growing in solution to the PDMS surface. These properties could potentially form a dense network of interconnected polymer chains. Indeed, as the percentage of DiPEG to PEG (weight/weight) increases beyond 10%, the PDMS slab becomes increasingly twisted and could no longer be flattened (FIG. 10B). This may be the result of excessive cross-linking leading to surface strain. However, as long as the ratio of DiPEG to PEG is below 10%, the flexibility and transparency of the PDMS was similar to that of native PDMS (FIG. 10A).

To determine how cross-linking the polymer strands impacts other surface properties, the contact angle of a water droplet, sealing properties, and μₑₒ of the cross-linked coatings are assessed. The contact angle of a water droplet on a flat slab of PDMS grafted with PEG:AA:DiPEG is the same as that for a surface grafted with only PEG:AA (Table II). Since the PEG:AA coating is already quite hydrophilic, cross-linking the polymers did not alter the contact angle. When the ratio of DiPEG/PEG in the grafting mixture is less than 10%, the grafted PDMS seals well with like surfaces when manually compressed together. As the ratio of DiPEG/PEG increases above 10%, a surface seal with like surfaces becomes increasingly more difficult due to the increasing hardness and twisting of the surface. To determine how the cross-linked coating influenced EOF, two PDMS halves of a microchannel are grafted with PEG:AA:DiPEG with the DiPEG/PEG ratio at 5%. After sealing the two halves, μₑₒ is measured (Table II). μₑₒ increases by over 150% compared to that of a microchannel grafted with only PEG:AA despite a lower absolute AA concentration in the PEG:AA:DiPEG grafting mixture since the total monomer concentration is maintained constant rather than the concentration of any one monomer (Table II). Referring to the following equation, μₑₒ=εζη where [epsilon] is the dielectric constant, [zeta] is the zeta potential of the liquid-solid interface, and [nu] is the viscosity of the solution near the solid surface. The cross-linked PEG:AA forms a nearly solid surface. [Zeta] arises largely from the interface between the cross-linked PEG:AA and the buffer solution. [Nu] is then dominated by the viscosity of the buffer solution in the capillary. In contrast, the linear strands of PEG:AA will form a viscous solution near the PDMS surface. The [zeta] potential then originates largely from the interface of the PDMS surface and the adjacent viscous PEG:AA solution. [Nu] is now dominated by the viscosity of the PEG:AA layer and acts to greatly diminish the EOF.

### EXAMPLE 4

### Electrophoretic Separation of Peptides in Channels with Cross-Linked PEG:AA

To determine whether cross-linking with DIPEG improved the separation of peptides, F-src and F-PKB are loaded into the injection channel of a device grafted with DiPEG, PEG, and AA. A plug of F-src and F-PKB is loaded from the injection channel into the separation channel and electrophoresed. F-src and F-PKB now appeared as two distinct peaks (FIG. 7C). To determine whether F-src and F-calc could also be separated on the cross-linked coating, F-src and F-calc are loaded into the injection channel and a plug injected into the separation channel. Two sharp peaks representing F-src and F-calc are now present on the electropherogram (FIG. 8C). The number of theoretical plates for the F-src and F-calc peaks was increased over 8 and 20 fold, respectively, compared to that in PEG:AA-grafted microchannels (Table III). In addition the peak migration times and areas were highly reproducible (Table III). The migration times of all peptides in channels with the cross-linked coating is considerably shorter compared to that in channels without cross-linked surfaces. This is consistent with the much greater EOF of the cross-linked coatings.

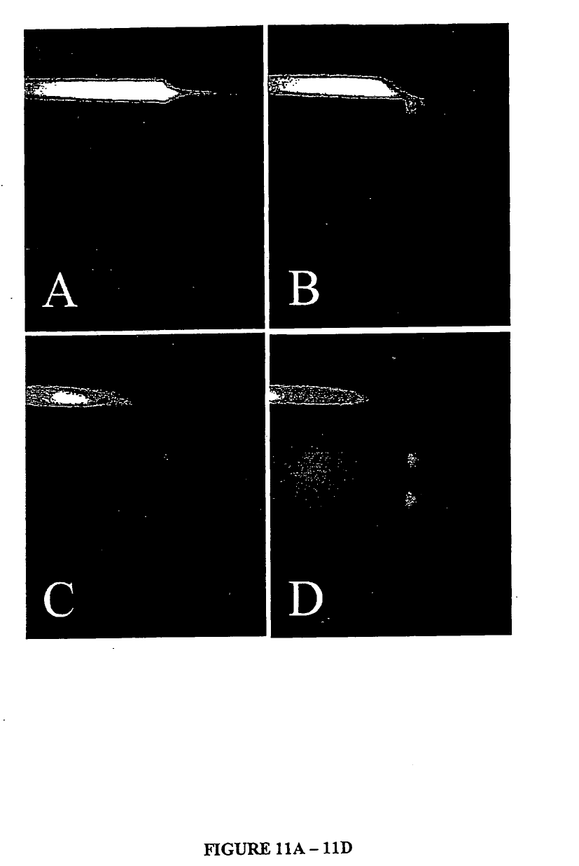

To determine how fast the separation of F-src and F-calc might occur and whether the analytes still visibly adsorbed to the coated surfaces, the analyte plug is imaged as it was pinched from the injection channel (FIG. 11A-D). Separation of the F-src and F-calc bands is visible by 200 ms after the separation is initiated (FIG. 11C). The fastest band (F-src) travels less than 250 micrometers in this time. Complete separation of F-src and F-calc is visible by micrometers ms and within a distance of less than 400 micrometers from the channel intersection. In addition no adsorption of the peptides within the injection channel is visible after pull-back of the analytes (FIG. 11D).

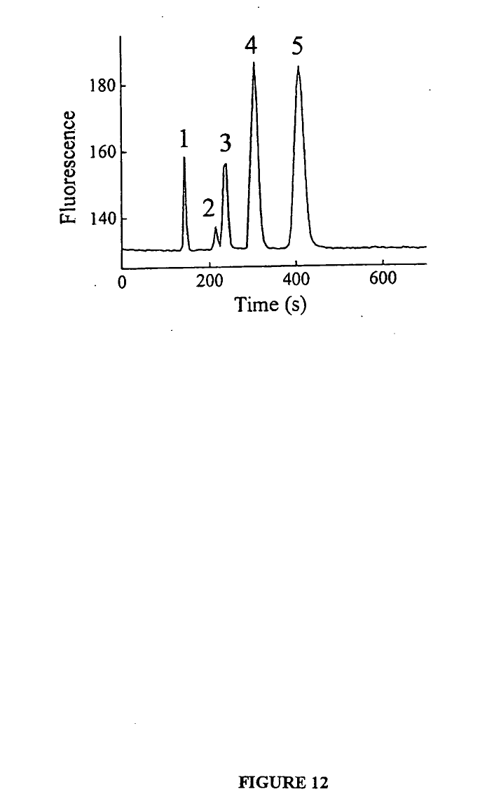

To determine whether greater numbers of peptides might also be separable in the channels with the cross-linked coatings, five peptides (F-src, F-PKB, PF-PKB, F-calc, PF-calc) are co-mixed, loaded, and electrophoresed in a device grafted with PEG:AA:DiPEG. All 5 peptides now appear as distinct peaks on the electropherogram (FIG. 12A). The PEG:AA:DiPEG-grafted microchannels are utilized for over 30 different electrophoretic runs without a decline in their performance as evidenced by constant migration times and maintenance of their separation efficiency. To determine whether an optimal ratio of PEG:AA:DiPEG existed for separations, microchannels were grafted with variable ratios of PEG:AA:DiPEG. All ratios of PEG:AA:DiPEG between 40:3:3 and 95:2:3 yield devices that performed equally well in the separation of the peptides. Therefore, a wide range of monomer ratios rather than one single ratio is suitable for coating the devices for these electrophoretic applications.

The ability to tailor the surface properties of PDMS microfluidic devices for electrophoretic applications is provided by grafting mixtures of monomers onto the surface. Three different monomers (PEG, AA, and DiPEG) produce three different classes of grafted surfaces (single, mixed, and cross-linked mixed monomer). Each coating exhibits unique surface properties attributable to the chemical properties of the monomers. For the test analytes the cross-linked, mixed monomer-grafted surfaces yield superior separations. The EOF generated by the cross-linked coatings is also considerably higher than that of similar non cross-linked coatings. The superior separations and higher μₑₒ may both result from the “hardening” of the coating by the cross-linker with decreased penetration of analytes, buffer ions, and water into the coating. The theoretical plates/cm (4800-7400 plates/cm) are superior to that attained for other coatings on PDMS and equivalent to the known best efficiencies on PDMS. Assets of these grafted coatings are the covalent linkage to the PDMS surface and the single reaction step. In addition the coating attributes are easily modified and optimized for different analytes by altering the identities and titrating the concentrations of the monomers.

### EXAMPLE 5

### Ocular Lens with Ultraviolet-Based Graft Polymer

As described above, the present invention provides a polymer graft that is tailored to provide desired surface properties based in a biomaterial based on the intended use. For ocular lenses, the important parameters are similar to those that are currently recognized for conventional contact lenses, but for which inherent physical properties of the commonly used polymers limit the ability to satisfy all of the desired parameters. These materials must be transparent to visual light to allow the wearer to see through the lens, the materials must be flexible and permeable to oxygen to maintain the health of the eye when the lens is worn. Depending on the nature of the substrate polymer, the materials may also have to contain a high water content to facilitate gas transport. Finally, the materials must be biocompatible stable when stood in solution, and must have an extremely low coefficient of friction.

Contact lenses are often formed from cross linking hydrophilic derivatives of vinylic, acrylic, or methacrylic polymers which often have a degree of cross-linking to provide structural integrity. The materials used to manufacture a lens of this invention include all of the commonly known monomers for the production of soft contact lens material including methacrylic acid, 2-hydroxyethyl methacrylate (HEMA), and other compounds known to those of ordinary skill in the art. Moreover, the manufacturing process for the polymer substrate, in this case the lens blank, is the same as for conventional lenses. Typically, such lens blanks are produced in molds shaped to conform to the surface of the eye. The monomer mixture used to form the substrate is inserted into a mold and heated to between approximately 60° C. and 120° C. The resulting lens blank is cured under an ultraviolet light for between approximately 5 to 20 minutes and preferably approximately 5 to 10 minutes. The curing process may be conducted under a nitrogen gas blanket for all or a portion of this time interval. The lens blank may be subjected to thermal post-curing at elevated temperature levels and may be separately hydrated and polished according to the specifications for the individual polymer used to form the blank. The specific contact lens compositions are based on known polymers compatible for use as contact lenses. The disclosures of U.S. Pat. Nos. 5,314,960, 5,270,415 and 4,990,561 are incorporated herein by reference.

The graft polymer of the present invention is ideal because the oxygen permeability of the underlying substrate is maintained. The requirement for oxygen permeability is necessary to supply oxygen to the tissue of the eye and to defend against bacterial infection. Any material that acts as a barrier to oxygen transport to the anterior ocular surface is not suitable as a substrate for the contact lens embodiment of the present invention. Typically, an average oxygenation level of at least 10 percent (equivalent oxygen percentage) is necessary for an adequate polymer substrate. The measurement of oxygen transport across a polymer membrane is easily measured by those of ordinary skill in the art and depends both upon the inherent oxygen permeability of the polymer substrate material, as well as the lens thickness and the ambient conditions. In traditional soft lens type ocular contact lenses, the polymer materials have a substantial water content that is relied upon to transport oxygen through the lens, by diffusion of the oxygen gas through the water phase of the material. More recently, highly gas permeable polymers have been developed that have the ability to pass oxygen gas through the polymer phase without the requirement for a high degree of hydration of the polymer itself. In either case, the graft polymer of the present invention is suitable as a coating for the lens blank substrate.

Selection of materials that do not contain a high water content may be preferred in some applications because the hydration reaction is thermodynamically reversible and soft contact lenses are known to loose hydration and exhibit less ideal surface chemistry properties over time. Generally speaking, polymer substrates having a high water content must be manufactured at a higher thickness than a low water counterpart to avoid loss of hydration of the material. The most modern materials are either water containing soft polymer films known as “hydrogels” or non water containing gas permeable polymers. The hydrogel lenses exist in two forms, the traditional typically acrylic polymers and polymer substrates formed from silicon hydrogels. As noted above, the materials are either homopolymers or copolymers and may contain varying degrees of cross linking agents to provide strength and structural integrity of the lens material. Suitable hydrogel materials include polyHEMA (poly-2-hydroxyethyl-methacrylate) and may have surface modification techniques employed to increase the water content.

Silicon-containing materials are a relatively recent development and offer exceptional oxygen permeability and structural durability. However, fluid is typically unable to flow across the lens materials, i.e., these materials exhibit poor wettability, and result in frequent adhesion of the lens to the ocular surface. Moreover, these lens surfaces are typically hydrophobic and exhibit lipid and protein deposition across the surface resulting from ordinary lipid and protein molecules present in the tears. Application of the graft polymer of the present invention decreases the coefficient of friction and provides excellent wettability that is superior to the inherent property of the underlying substrate polymer.

As is apparent from the foregoing, no single material provides an ideal solution for selecting the physical and chemical properties of the substrate polymer for the contact lens blank. In one technique, two different materials are combined to attempt to gain the positive properties of each. However, the material can separate into different phases and lose transparency when manufactured into a contact lens. Moreover, the techniques for synthesizing such compounds are extremely complex. Attempts to overcome the inherently hydrophobic nature of some materials include surface bombardment techniques and the exposure to gas plasma to attempt to alter the surface of the silicon polymer. In hydrogels, the wettability requires a biocompatible surface to be deposited on the lens to ensure adequate freedom from friction between the lens and the eye. In some cases, the patient provides a suitable layer through ordinary wear, but this phenomenon cannot be relied upon from patient to patient.

The attachment of the graft polymer as described above is achieved by incorporating the graft deposition process into the lens manufacturing step. Thus, the immersion of the contact lens into a graft polymer solution is achieved to supply the graft monomer in a uniform layer on the lens substrate. As described above, the grafted contact lens is subjected to 5 to 10 minutes of ultraviolet light with a high watt mercury lamp. To optimize the manufacturing procedure, the wattage of the mercury lamp can be increased to decrease the length of exposure time, as long as the desired wavelengths of approximately 300 nm are maintained. Also, the orientation of the lamp and the concentration of the monomer in solution can be adjusted to optimize the process. While the above described process is suitable for contact lenses of the “soft” type commonly used, the polymer grafting aspect of the invention can be applied to lenses formed of rigid polymer substrates for extra ocular use as well as intraocular implants and other ocular prostheses. The graft polymer of the present invention, when applied to an intraocular lens, may be homogenous or heterologous population of monomers as described above. In a particularly preferred embodiment, approximately 10 percent polyethylene glycol (PEG) was fixed to a hydrogel-based lens. The lens substrates are immersed and circulated in a bath of PEG monomer as described previously for between 30 and 90 minutes at ambient temperature or at an elevated temperature compatible with the underlying lens substrate. Depending on the chemical composition of the polymer substrate, the graft polymer may be modified to adjust the thickness or density of the graft polymer in order to achieve a desired coefficient of friction. Generally, the process parameters can be altered, once the substrate polymer is chosen and a graft polymer composition determined, to reduce the coefficient of friction to the lowest possible value consistent with maintaining the transparency, permeability, and flexibility of the lens.

The graft polymer of the present invention provides a low-friction coating layer that increases the performance of all of the standard materials used in contact lenses. As noted above, the selection of monomers and treatment conditions can be tailored to produce a polymer film that is highly flexible and permeable to oxygen gas. Thus, the advantages of both a high water content polymer and a highly gas-permeable polymer are maintained and enhanced using the polymers of the present invention. In use, the invention is comprised of a contact lens substrate being formed of any conventional material to which is applied a surface polymer graft applied by exposure to ultraviolet radiation according to the techniques described above. The contact lenses of the invention are distinguished from conventional lenses by the attachment of a surface polymer graft that is discreet from the lens material and which imparts a separate set of surface parameters to the lens itself. The surface graft polymers of the present invention can be applied to either or both sides of a contact lens by ordinary manufacturing techniques. Ideally, the length of ultraviolet light exposure required to deposit the surface graft is adjusted to be compatible with the use of a curing step, when necessary, in the lens manufacturing process.

### EXAMPLE 6

### Graft Polymers in a Polymer Microdevice

Miniaturization of biochemical analytical systems, employing microfluidic processing techniques and other small scale manufacturing techniques used in the microelectronics industry, enable the development devices that perform chemical and biochemical reactions in a miniaturized format typically referred to as “lab-on-a-chip” technology. Application of microfluidics technology embodied in the form of analytical devices has many attractive features for sample testing. Advantages of these systems include greatly increased throughput and reduced costs, in addition to low consumption of both sample and reagents and system portability. With these devices, referred to herein as polymer microdevices, sample preparation, processing, and analysis is conducted within microfluidic-based devices that direct fluids through a network of interconnecting microchannels of capillary dimensions, perform separation functions, detection functions, and others on a polymer substrate having grafts of the present invention applied to selected portions thereof.

Microfluidic devices provide fluidic networks in which biochemical reactions, sample injections and separation of reaction products are performed rapidly and reproducibly. The application of voltage to conductive fluids within these channels leads to electroosmotic and/or electrophoretic pumping, providing both mass transport and separation of components within the sample. In these microfluidic devices, fluid flow and reagent mixing is achieved using electroosmotic and electrophoretic transport phenomena. Fluid transport is typically controlled by regulating the applied potentials at the terminus of each channel of the microfluidic device. Within the channel network, cross intersections and mixing intersections are used for directing and dispensing fluids with high volumetric reproducibility. The mixing intersection can be used to quantitatively control the combination of two fluid samples by selective alteration of the electric potential across the device. Also, channels may have fluid pressure imparted to control fluid flow and the combination of EOF and fluid pressure may be used.

Capillary-based separations are widely used for analysis of a variety of analyte species. Numerous subtechniques, all based on electrokinetic-driven separations, have been developed. Capillary electrophoresis is one of the more popular of these techniques and can be considered to encompass a number of related separation techniques, including electrophoresis.

In some instances a prerequisite for conducting assays on microfluidic devices is the ability to transport large proteins (positively and negatively charged), substrates, cofactors and inhibitors or test compounds. Electroosmotic pumping has to be used to transport reagents and samples. Therefore, control of the electroosmotic flow (EOF), surface charge of the polymer substrate and capillary wall chemistry is critical to the success of a microfluidic device.

Surface modifications of the polymer substrates of polymer microdevices has been an area of active research since the introduction of such devices because commonly used solutions and analytes, especially proteins, undergo adsorption onto the polymer substrate itself. The interaction of analytes with the polymer material leads to the inability to effectively separate and measure analytes in solution. The adsorption of proteins on the polymer surface is a common problem in the analysis of proteins by electrophoresis in microdevices. Although buffer additives, non-covalent coating and covalent coating have been reported to decrease protein adsorption on some surfaces, protein grafts with UV-based techniques have not been applied to microdevices.

The methods and devices of the present invention include a UV-based graft polymers to a polymer substrate in a microdevice to provide more efficient manufacturing, improved flow, and greatly enhanced separation of analytes in a microfluidic device.

The polymer compositions, microfluidic devices and methods of analysis and manufacture enabled by the present invention do not suffer the drawbacks of known methods and materials and are inexpensive, practical, and easy to use. One of the advantages of the methods and compositions of the present invention is that the surface properties of a polymer substrate can be tailored so that the reagents and products of any biochemical reaction, namely, negatively charged, neutral and positively charged products, are readily transported, separated and analyzed in a microfluidic device. The graft polymer may increase or decrease hydrophobicity or hydrophillicity at selected portions of the device. Also, at least two discrete graft polymers may be applied to the surface of the device to impart discrete surface chemistries to different portions of the substrate surface.

As mentioned above, the present method involves controlling the direction and transport of a material by selective polymer grafts onto a polymer substrate. The substrate may also include a reagent, such as a ligand or receptor, which is synthetic or natural, antigenic or haptenic, a single compound or plurality of compounds. The material may be a test compound from a combinatorial library, a pharmacophore from an existing library, and the like. The low molecular weight ligands include small molecules, hormones, co-factors, metabolites, and the like. Higher molecular weight ligands generally have a molecular weight of at least about 5,000, more usually at least about 10,000, and include, for example poly(amino acids) such as proteins, polynucleotides, immunoglobulins, enzymes, and binding pair members. Polynucleotides include RNA, RNAi, DNA, cDNA, polynucleotide duplexes, amplicons, binding complexes, etc. The analyte may also include any of these compounds for analysis in the device.

Electrophoresis generally involves separation of components in a liquid by application of electricity to a sample in a medium. Various forms of electrophoresis include, by way of example and not limitation, free zone electrophoresis, gel electrophoresis, and capillary zone electrophoresis.

Polymer microdevices may also contain interconnected reservoirs and capillary-size channels configured with a plurality of branches through which fluids may be manipulated and processed. A reservoir structure is an unfilled space that may contain a fluid such as buffer, electrolyte, sample or reagent in a discrete component for use in the function of the device. Reservoirs may be at a terminus of a capillary channel. The reservoir may allow rinse or mixing functions and generally are connected by the channels to produce fluid communication.

Sample processing involves fluid transport, sample analytical reactions and detection within the reservoirs and channels. Sample and fluid transport may also involve reagent mixing, reaction/incubation, separations and sample detection and analyses. The thickness at the surface graft polymer is adjustable to be less than the depth at a channel in the microdevice.

The sample usually contains one or more materials of interest, such as differentially charged chemical species. Typical sources for mammalian biological samples include body fluids, serum or plasma, ascites, cells and cell extracts etc. Other sources of samples are aqueous or water soluble solutions of natural or synthetic compounds. Sample volumes typically range from about 1 to about 1,000 nanoliters, and usually between about 10 and about 100 nanoliters. The microdevices of the present invention also include a detection system to qualitatively detect, or quantitatively, measure the reactions carried out in the device. Chemical entities capable of being detected include spectrophotometric, chemiluminescent, electrochemical or radiochemically active compounds. The reporter molecule can be capable of conjugation to another molecule, such as the members of a binding pair. Reporters can be directly detected or indirectly detected through a production of a signal. Suitable candidates are a catalyst, dye, fluorophone, chemiluminescent molecule, or other compounds used in ordinary biochemical reactions detection. The surface of the polymer substrate that contacts any situation or analyte within a microfluidic device, may be tailored to achieve any of the objectives cited previously. For example, the microfluidic channels may be treated with surface graft polymers to facilitate flow from one region of the microdevice to another, with or without achieving mixture, separation, or analysis during the transport. Preferably, distinct regions of the microdevice are grafted with surface polymers to facilitate peptide separation, cell separation, or bioanalytical assays to qualitatively or quantitatively measure analytes in a sample based on their differential reactivity with the surface coatings. Thus, the polymer microdevices of the present invention contain areas where two or more surface graft polymers have been applied to facilitate different fluid transfer properties, different surface adsorption properties, or other separation parameters dictated by the individual properties of a solution or analyte. In a particularly preferred embodiment, increased separation capabilities for polypeptides and complete proteins are achieved by surface grafts of polymers onto an underlying polymer substrate that forms the body of the microdevice. The surface graft polymer exhibits separation capabilities for a peptide analyte of interest by altering the charge or adsorption properties across a channel where the analyte is caused to flow. Examples of peptide separation on monomer substrates are provided above and may be based on charge or mass separation interactions occurring between the analyte and the surface of the polymer.

Thus, in addition to control of adsorption parameters, the combination of the surface graft of the invention with other assay components can provide significant optimization to an assay protocol by controlling fluid flow, affinity of analytes for substrate, and control of the charged characteristics of the substrate polymer. For example, by reducing a high positive charge on a monomer species, analyte separation can be achieved through selective application of a negative charge across a polymer graft. Essentially, any surface charge and adsorption parameters can be tailored to an individual application by selection of the monomer, or combination of monomers used to form the surface graft as described previously. The surface graft components can be integrated into any of the fundamental structural components of a microfluidic device. The fundamental structural components of a microfluidic device include at least one flowpath, a reservoir and an electrode connected to a reservoir. The establishment of electrical potentials across the flowpath induces fluid flow. The device also typically has a detection zone for the detection of signal produced during the assay using any of these signal detection moieties described above. Obviously, the device may have multiple detection zones and the zones may have dedicated detectors as well as an exitation source such as a fluorescent or visible light beam that is integral to the microdevice or is separately integrated into a processor or reader.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

The invention and its various embodiments are thus to be understood to include what is specifically illustrated and described above, what is conceptionally equivalent, what can be obviously substituted and also what essentially incorporates the essential idea of the invention. All publications, patents and references cited herein are specifically incorporated by reference in their entirety.

1. A combination of a polymer substrate and a surface graft polymer comprising:
a polymer substrate molded into a configuration to be accessible by light and capable of forming a free radical from a carbon or oxygen atom at the surface of the substrate;
a graft polymer adhered to the surface of the substrate wherein the graft polymer is comprised of at least one monomer and where the monomer is miscable in a solution comprising a chain transfer agent, and wherein the surface graft polymer forms a coating on the polymer substrate upon exposure to UV light.

2. The polymer substrate-graft combination of claim 1 wherein the solution contains a photo initiator.

3. The polymer substrate-graft combination of claim 1 wherein the solution contains a cross-linking agent.

4. The polymer substrate-graft combination of claim 1 wherein the solution contain a monomer selected from the group of PEG, AA, monomethoxy acrylate PEG, HEMA, or DMA.

5. The polymer substrate-graft combination of claim 1 wherein the graft polymer is comprised of at least two monomers.

6. The polymer substrate-graft combination of claim 1 wherein the solution contains a two monomers are selected from the group of PEG, AA, monomethoxy acrylate PEG, HEMA, or DMA.

7. The polymer substrate-graft combination of claim 1 wherein the substrate is PDMS.

8. The polymer substrate-graft combination of claim 1 wherein the substrate is PDMA.

9. An ocular lens having a polymer substrate and a surface graft polymer coated the surface of the substrate comprising:
a transparent polymer substrate that is permeable to oxygen;
a transparent surface graft polymer coating the polymer substrate wherein the graft polymer is comprised of at least one monomer that forms the surface graft on the substrate by exposure to UV light.

10. The lens of claim 9 wherein the substrate is shaped to conform to the surface of the eye.

11. The lens of claim 10 wherein the surface graft polymer is PEG.

12. The lens of claim 10 wherein the polymer substrate is a hydrogel.

13. The lens of claim 10 wherein the polymer substrate contains silicon.

14. A method to manufacture a contact lens comprising:
forming a lens blank of a transparent polymer shaped to conform to the surface of the eye;
coating the lens blank with a surface graft polymer by immersing the blank in a solution containing at least one monomer and a chain transfer agent and then;
exposing the lens blank and the monomer to UV light to form the graft polymer as a coating on the surface of the lens.

15. The method of claim 14 wherein the substrate is a hydrogel.

16. The method of claim 14 wherein the substrate contains silicon.

17. The method of claim 14 wherein the solution containing at least one monomer is selected from the group of PEG, AA, monomethoxy acrylate PEG, HEMA, or DMA.

18. The method of claim 14 wherein the solution containing at least two monomers is selected from the group of PEG, AA, monomethoxy acrylate PEG, HEMA, or DMA.

19. A polymer microdevice formed of a polymer substrate and comprising:
microfluidic channels for fluid transport wherein the surface of the microdevice is comprised of a graft polymer applied by coating the surface with a monomer solution and exposure to UV light.

20. The microdevice of claim 19 wherein the graft polymer has a surface thickness less than a depth of the microfluidic channels of the device.

21. The microdevice of claim 19 wherein the graft decreases the hydrophobicity of at least a portion of the substrate polymer.

22. The microdevice of claim 19 wherein at least two different polymer grafts are applied to the microdevice.

23. A method to produce a polymer microdevice comprising:
providing a microdevice having a polymeric substrate, a plurality of microchannels for fluid movement, and a reservoir for containing reagents,
applying a polymer graft to the surface of the microdevice.

24. The method of claim 23 wherein the graft polymer is formed by exposure of monomers in solution to UV light.

25. The method of claim 23 wherein the solution containing monomers also contains a chain transfer agent.

26. The method of claim 23 wherein the solution containing monomers also contains a cross-linking agent.

27. The method of claim 23 wherein the solution containing monomers also contains a photoinitiator.

28. The method of claim 23 wherein the graft polymer is formed of monomers selected from the group of PEG, AA, monomethoxy acrylate PEG, HEMA, or DMA.

29. The method of claim 23 wherein the graft polymer is formed of at least two monomers selected from the group of PEG, AA, monomethoxy acrylate PEG, HEMA, or DMA.

30. The method of claim 23 further comprising forming a second polymer graft on the surface of the microdevice.
